(19) United States
(12) Patent Application Publication
(10) Pub. No.: US 2024/0218092 A1
(43) Pub. Date: Jul. 4, 2024

(54) Guaiazulene-Based Metallocene Catalysts for Olefin Polymerization

(71) Applicant: ExxonMobil Chemical Patents Inc., Baytown, TX (US)

(72) Inventors: Nikola S. Lambic, Houston, TX (US); Gregory J. Smith-Karahalis, Houston, TX (US)

(21) Appl. No.: 18/519,762

(22) Filed: Nov. 27, 2023

Related U.S. Application Data
(60) Provisional application No. 63/387,051, filed on Dec. 12, 2022.
(60) Provisional application No. 63/496,843, filed on Apr. 18, 2023.

(51) Int. Cl. C08F 10/02; C07F 17/00; C08F 10/06

(52) U.S. Cl. CPC C08F 10/02; C07F 17/00; C08F 10/06; C08F 2420/10

(57) ABSTRACT

Catalyst compositions are disclosed herein, as well as embodiments of catalyst systems and their use in the production of olefin polymers. The catalysts disclosed herein are simple organometallic, metallocene complexes having at least one guaiazulene-based ligand (e.g., guaiazulene or a guaiazulene derivative). Additionally, the catalyst can be combined with an activator, such as methyl alumoxane and/or a non-coordinating anion to provide a catalyst system. Either the catalyst or the catalyst system can be combined with a support, such as silica and/or alumina. The catalyst system, supported or unsupported, can be used to polymerize olefins, such as propylene or ethylene.

### CROSS REFERENCE TO RELATED APPLICATIONS

This application claims the benefit of and priority to both U.S. Provisional Application No. 63/387,051 filed Dec. 12, 2022, and U.S. Provisional Application No. 63/496,843 filed Apr. 18, 2023, the disclosures of which are incorporated herein by reference.

### FIELD

The subject matter disclosed herein relates to metallocene catalyst compounds and catalyst systems comprising at least one guaiazulene-based moiety, as well as uses thereof in olefin polymerization applications.

### BACKGROUND

Metallocene catalysts are ubiquitous in the polyolefin industry and often feature complicated ligand scaffolds that are prepared via tedious multi-step syntheses. For these metallocene catalysts, significant diversification comes at a substantial cost penalty, which often limits the practical usage of highly complex catalysts. Additionally, while there is interest in finding new metallocene catalyst systems that enable the production of olefin polymers having specific properties, such as high melting point and high molecular weight, it is also presently recognized that certain materials used in the syntheses of metallocene catalysts may not be widely produced at scale or easily obtainable at low cost. This undesirably increases the difficulty and cost of synthesizing the metallocene catalysts, which also undesirably increases the overall cost of production of olefin polymers.

Other references of interest include U.S. Pat. Nos. 9,266,910, 7,906,599, 7,122,604, 7,115,694, 6,825,280, 6,825,371, and 5,510,502; U.S. Patent Publication Nos. 2006/0025535 and 2005/0124753; JP Patent Nos. JP4214792B2, JP3713405, JP3701147, JP4244403, JP11349634, JP11349618, JP11349617, JP11240929, JP4482771, JP11228612, JP3561623, JP11140111, JP11140112, JP11012290, JP3942227, and JP3739701; JP Patent Publication Nos. JP20218449, JP2004035519, JP2005336092, JP2005336091, JP2005048033, JP2005002158, JP2004300192, JP2004002310, JP2000026489, JP2000026477, and JP2017145240; CN Patent No. CN100436490; Burger, P. et al. (1989) “ansa-Metallocene Derivatives-XVIII*. Chiral Titanocene Derivatives Accessible from Substituted Dihydropentalene and Azulene Precursors,” Jrnl. Organometallic Chem., v. 378(2), pp. 153-161; Fedushkin, I. et al. (2003) “Diastereoselective Formation of Calcium and Ytterbium ansa-metallocenes via Recombination of Guaiazulene (Gaz) Radical Anions. Molecular Structure of ansa-(η⁵-Gaz)₂Ca(THF)₂ and ansa-(η⁵-Gaz)₂Yb(Py)₂ (Gaz=1,4-dimethyl-7-isopropylazulene) Complexes,” Russ.Chem.Bull., Int.Ed., v. 52(6), pp. 1363-1371; Richter, J. et al. (2018) “Early Transition Metal and Lanthanide Metallocenes Bearing Dihydroaulenide Ligands, Inorganica Chimica Acta, v. 475, pp. 18-27; Iwama, N. et al. (2005) “Novel Bridged bis-azulenyl and bis-tetrahydroazulenyl Hafnocenes: Synthesis, Structure, and Propylene Polymerization Behavior,” Jrnl. of Organometallic Chem., v. 690(9), pp. 2220-2228; Iwama, N. et al. (2004) “Photochemical Intramolecular [2+2] Cycloaddition of Bridged Bis-azulenyl Zirconocenes,” Organometallics, Vol. 23(24), pp. 5813-5817; and Iwama, N. et al. (2005) “Synthesis, Structure, and Polymerization Behavior of Novel Azulenyl Metallocenes Producing Propylene-Ethylene Pseudo-Copolymer,” Organometallics, v. 24(1), pp. 132-135.

### SUMMARY

This disclosure relates to a method to polymerize olefins comprising contacting a catalyst compound with an activator and one or more monomers. This disclosure further relates to novel catalyst compounds. This disclosure further relates to polymer compositions produced by the methods described herein.

Embodiments of new catalyst compositions are provided, as well as embodiments of catalyst systems and their use in the production of olefin polymers. Embodiments of the catalysts disclosed herein are simple organometallic, metallocene complexes having at least one guaiazulene-based ligand (e.g., guaiazulene or a guaiazulene derivative). The catalyst embodiments disclosed herein unexpectedly demonstrate excellent activity, as well as significant improvement in molecular weight capability for polyethylene and ethylene-octene copolymers, at a reduced cost relative to conventional catalysts prepared from azulene derivatives. Additionally, certain catalyst embodiments disclosed herein demonstrate relatively poor comonomer incorporation, which can be advantageous to certain olefin polymerizations.

Embodiments of the guaiazulene-based catalysts described herein are generally represented by the formula:

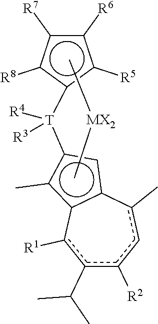

wherein:
M is a transition metal atom selected from group 4 of the Periodic Table of Elements;
each X is a univalent anionic ligand, or two Xs are joined and bound to the metal atom to form a metallocycle ring, or two Xs are joined to form a chelating ligand, a diene ligand, or an alkylidene ligand;
T is an optional bridging group that includes R² and R³, which are each independently a substituted or unsubstituted C₁ to C₂₀ hydrocarbyl group and can be joined to form a cyclic structure;
R⁵, R⁶, R⁷ and R⁸ are each independently a hydrogen atom or a substituted or unsubstituted C₁ to C₂₀ hydrocarbyl group and any two of R⁵, R⁶, R⁷, and R⁸ adjacent to each other can be joined to form a cyclic structure (e.g., a 7-member ring of guaiazulene or a guaiazulene derivative);
R¹ and R² are independently a hydrogen atom or a substituted or unsubstituted C₁ to C₂₀ hydrocarbyl group; and the dashed bonds indicate optional double bonds.

Certain embodiments of the guaiazulene-based catalysts described herein are bridged, cyclopentadiene/guaiazulene metallocenes, also referred to herein as ansa guaiazulene metallocenes, more specifically represented by the formula:

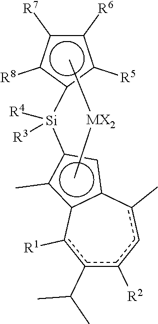

wherein:
M is a transition metal atom selected from group 4 of the Periodic Table of Elements;
each X is a univalent anionic ligand, or two Xs are joined and bound to the metal atom to form a metallocycle ring, or two Xs are joined to form a chelating ligand, a diene ligand, or an alkylidene ligand;
R³ and R⁴ are each independently a substituted or unsubstituted C₁ to C₂₀ hydrocarbyl group and can be joined to form a cyclic structure;
R⁵, R⁶, R⁷ and R⁸ are each independently a hydrogen atom or a substituted or unsubstituted C₁ to C₂₀ hydrocarbyl group and any two of R⁵, R⁶, R⁷, and R⁸ adjacent to each other can be joined to form a cyclic structure;
R¹ and R² are a hydrogen atom or a substituted or unsubstituted C₁ to C₂₀ hydrocarbyl group; and
the dashed bonds indicate optional double bonds.

Certain embodiments of the guaiazulene-based catalysts described herein are bridged, bis-guaiazulene metallocenes more specifically represented by the formula:

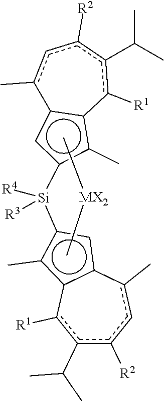

wherein:
M is a transition metal atom selected from group 4 of the Periodic Table of Elements;
each X is a univalent anionic ligand, or two Xs are joined and bound to the metal atom to form a metallocycle ring, or two Xs are joined to form a chelating ligand, a diene ligand, or an alkylidene ligand;
R³ and R⁴ are each independently a substituted or unsubstituted C₁ to C₂₀ hydrocarbyl group and can be joined to form a cyclic structure;
R¹ and R² are a hydrogen atom or a substituted or unsubstituted C₁ to C₂₀ hydrocarbyl group; and
the dashed bonds indicate optional double bonds.

Certain guaiazulene-based catalysts described herein are unbridged, bis-guaiazulene metallocenes more specifically represented by the formula:

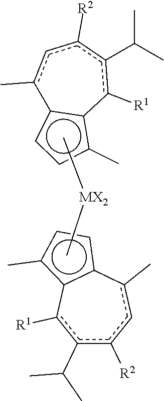

wherein:
M is a transition metal atom selected from group 4 of the Periodic Table of Elements;
each X is a univalent anionic ligand, or two Xs are joined and bound to the metal atom to form a metallocycle ring, or two Xs are joined to form a chelating ligand, a diene ligand, or an alkylidene ligand;
R¹ and R² is a hydrogen atom or a substituted or unsubstituted C₁ to C₂₀ hydrocarbyl group; and
the dashed bonds indicate optional double bonds.

It should be understood that any of the selections of substituents and groups noted above can be combined in any manner and are not limiting. Additionally, the catalyst can be combined with an activator, such as methyl alumoxane and/or a non-coordinating anion to provide a catalyst system. Either the catalyst or the catalyst system can be combined with a support, such as silica and/or alumina. The catalyst system, supported or unsupported, can be used to polymerize olefins, such as propylene or ethylene.

These and other features and attributes of the disclosed guaiazulene-based catalysts of the present disclosure and their advantageous applications and/or uses will be apparent from the detailed description which follows.

### BRIEF DESCRIPTION OF THE DRAWINGS

To assist those of ordinary skill in the relevant art in making and using the subject matter hereof, reference is made to the appended drawings, wherein:

FIG. 1 is a set of chemical structures representing embodiments I1, I2, I3, I4, I5, I6, I7, and I8 of inventive guaiazulene-based catalysts, in accordance with certain embodiments of the present disclosure.

FIG. 2 is a set of chemical structures representing comparative catalysts C₁, C₂, C₃, C₄, C₅, C₆, C₇, C₈, and C₉, in accordance with certain embodiments of the present disclosure.

FIG. 3 is a bar graph that illustrates the average activity for each of the comparative catalysts (i.e., C₁-C₉) and each of the embodiments of the inventive guaiazulene-based catalysts (i.e., I1-I8) during example olefin polymerization processes, in accordance with certain embodiments of the present disclosure.

FIG. 4 is a bar graph that illustrates the mean molecular weight (Mw) for the polymer product produced by each of the comparative catalysts (i.e., C₁-C₉) and each of the embodiments of the inventive catalysts (i.e., I1-I8) during the example olefin polymerization processes, in accordance with certain embodiments of the present disclosure.

FIG. 5 is a set of graphs plotting melting temperature (Tm) versus weight percent of 1-octene comonomer for the polymer product produced by each of the comparative catalysts (i.e., C₁-C₉) and each of the embodiments of the inventive catalysts (i.e., I1-I8) during the example olefin polymerization processes, in accordance with certain embodiments of the present disclosure.

FIG. 6 represents an ORTEP drawings (50% probability ellipsoids) as well as unit cell parameters obtained from X-ray crystallography for inventive catalysts I2, I3 and I4 in accordance with certain embodiments of the present disclosure.

### DETAILED DESCRIPTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. All numerical values within the detailed description herein are modified by “about” the indicated value, and take into account experimental error and variations that would be expected by a person having ordinary skill in the art.

For the purposes of this disclosure and the claims thereto, the new numbering scheme for the Periodic Table Groups is used as described in Chemical and Engineering News, 63(5), p. 27 (1985). Therefore, a “Group 4 metal” is an element from Group 4 of the Periodic Table, e.g., hafnium (Hf), titanium (Ti), or zirconium (Zr).

Unless otherwise indicated, “catalyst productivity” is a measure of how many kg of polymer (P) are produced using a polymerization catalyst comprising mmol of catalyst (cat), over a period of time of T hours; and may be expressed by the following formula: P/(T×W) and expressed in units of kgPmmolcat-1 hr-1. Unless otherwise indicated, “conversion” is the amount of monomer that is converted to polymer product, and is reported as mol % and is calculated based on the polymer yield and the amount of monomer fed into the reactor. Unless otherwise indicated, “catalyst activity” is a measure of how active the catalyst is, and is reported as the mass of product polymer (P) produced per millimole of catalyst (cat) used (kgP/mmolcat).

An “olefin,” alternatively referred to as “alkene,” is a linear, branched, or cyclic compound of carbon and hydrogen having at least one double bond. For purposes of this specification and the claims appended thereto, when a polymer or copolymer is referred to as comprising an olefin, the olefin present in such polymer or copolymer is the polymerized form of the olefin. For example, when a copolymer is said to have an “ethylene” content of 35 wt % to 55 wt %, it is understood that the mer unit in the copolymer is derived from ethylene in the polymerization reaction and said derived units are present at 35 wt % to 55 wt %, based upon the weight of the copolymer. A “polymer” has two or more of the same or different mer units. A “homopolymer” is a polymer having mer units that are the same. A “copolymer” is a polymer having two or more mer units that are different from each other. A “terpolymer” is a polymer having three mer units that are different from each other. “Different” as used to refer to mer units indicates that the mer units differ from each other by at least one atom or are different isomerically. Accordingly, the definition of copolymer, as used herein, includes terpolymers and the like. An oligomer is typically a polymer having a low molecular weight (e.g., a Mn of less than 25,000 g/mol, or less than 2,500 g/mol) or a low number of mer units (such as 75 mer units or less). An “ethylene polymer” or “ethylene copolymer” is a polymer or copolymer comprising at least 50 mole % ethylene derived units, a “propylene polymer” or “propylene copolymer” is a polymer or copolymer comprising at least 50 mol % propylene derived units, and so on.

For the purposes of this disclosure, ethylene shall be considered an α-olefin.

For purposes of this disclosure, the term “substituted” means that a hydrogen group has been replaced with a heteroatom, or a heteroatom containing group. For example, a “substituted hydrocarbyl” is a radical made of carbon and hydrogen where at least one hydrogen is replaced by a heteroatom or heteroatom containing group.

As used herein, Mn is number average molecular weight, Mw is weight average molecular weight, and Mz is z average molecular weight, wt % is weight percent, mol % is molar percent, and vol % is percent by volume. Molecular weight distribution (MWD), also referred to as polydispersity, is defined to be Mw divided by Mn. Unless otherwise noted, all molecular weight units (e.g., Mw, Mn, Mz) are grams per mole (g/mol).

The following abbreviations may be used herein: Me is methyl, Et is ethyl, Pr is propyl, cPR is cyclopropyl, nPr is n-propyl, iPr is isopropyl, Bu is butyl, nBu is normal butyl, iBu is isobutyl, sBu is see-butyl, tBu is tert-butyl, Oct is octyl, Ph is phenyl, Bn is benzyl, MAO is methylalumoxane, Ind is indenyl, Cp is cyclopentadienyl, Flu is fluorenyl, OTf is triflate, RT is room temperature, or 23 degrees Celsius (° C.), unless otherwise indicated.

A “catalyst system” is combination of at least one catalyst compound, at least one activator, an optional co-activator, and an optional support material. For the purposes of this disclosure, when catalyst systems are described as comprising neutral stable forms of the components, it is well understood by one of ordinary skill in the art, that the ionic form of the component is the form that reacts with the monomers to produce polymers.

In the description herein, the metallocene catalyst may be described as a catalyst precursor, a pre-catalyst compound, metallocene catalyst compound or a transition metal compound, and these terms are used interchangeably. A polymerization catalyst system is a catalyst system that can polymerize monomers to form a polymer. An “anionic ligand” is a negatively charged ligand which donates one or more pairs of electrons to a metal ion. A “neutral donor ligand” is a neutrally charged ligand which donates one or more pairs of electrons to a metal ion.

A metallocene catalyst is defined as an organometallic compound with at least one π-bound cyclopentadienyl moiety (or substituted cyclopentadienyl moiety) and more frequently two π-bound cyclopentadienyl moieties or substituted cyclopentadienyl moieties.

For purposes of this disclosure, in relation to metallocene catalyst compounds, the term “substituted” means that a hydrogen group has been replaced with a hydrocarbyl group, a heteroatom, or a heteroatom containing group. For example, methyl cyclopentadiene (Cp) is a Cp group substituted with a methyl group, ethyl alcohol is an ethyl group substituted with a hydroxyl group.

The terms “hydrocarbyl radical,” “hydrocarbyl” and “hydrocarbyl group” are used interchangeably throughout this document. Likewise the terms “group”, “radical”, and “substituent” are also used interchangeably in this document. For purposes of this disclosure, “hydrocarbyl radical” is defined to be a radical, which contains hydrogen atoms and up to 100 carbon atoms and which may be linear, branched, or cyclic, and when cyclic, aromatic or non-aromatic. A “substituted hydrocarbyl” is a radical made of carbon and hydrogen where at least one hydrogen is replaced by a heteroatom or heteroatom containing group.

### Catalyst Compounds

Embodiments of the catalysts disclosed herein are simple organometallic, metallocene complexes having at least one guaiazulene-based ligand (e.g., guaiazulene or a guaiazulene derivative). Despite large steric constraint imposed by such ligands, the catalyst embodiments disclosed herein unexpectedly demonstrate excellent activity, as well as significant improvement in molecular weight capability for polyethylene and ethylene-octene copolymers, at the fraction of the cost of conventional catalysts prepared from azulene derivatives. Additionally, certain catalyst embodiments disclosed herein demonstrate relatively poor comonomer incorporation, which can be advantageous to certain olefin polymerizations.

Embodiments of the guaiazulene-based catalysts described herein are generally represented by the formula:

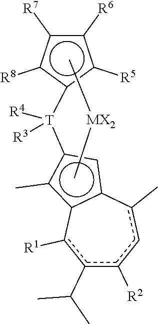

wherein:
M is a transition metal atom selected from group 4 of the Periodic Table of Elements;
each X is a univalent anionic ligand, or two Xs are joined and bound to the metal atom to form a metallocycle ring, or two Xs are joined to form a chelating ligand, a diene ligand, or an alkylidene ligand;
T is an optional bridging group that includes R² and R³, which are each independently a substituted or unsubstituted C₁ to C₂₀ hydrocarbyl group and can be joined to form a cyclic structure;
R⁵, R⁶, R⁷ and R⁸ are each independently a hydrogen atom or a substituted or unsubstituted C₁ to C₂₀ hydrocarbyl group and any two of R⁵, R⁶, R⁷, and R⁸ adjacent to each other can be joined to form a cyclic structure (e.g., a 7-member ring of guaiazulene or a guaiazulene derivative);
R¹ and R² are independently a hydrogen atom or a substituted or unsubstituted C₁ to C₂₀ hydrocarbyl group; and
the dashed bonds indicate optional double bonds.

Certain embodiments of the guaiazulene-based catalysts described herein are bridged, cyclopentadiene/guaiazulene metallocenes, also referred to herein as ansa guaiazulene metallocenes, more specifically represented by the formula:

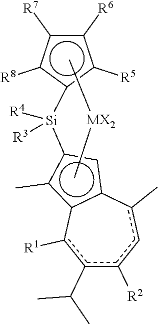

wherein:
M is a transition metal atom selected from group 4 of the Periodic Table of Elements;
each X is a univalent anionic ligand, or two Xs are joined and bound to the metal atom to form a metallocycle ring, or two Xs are joined to form a chelating ligand, a diene ligand, or an alkylidene ligand;
R³ and R⁴ are each independently a substituted or unsubstituted C₁ to C₂₀ hydrocarbyl group and can be joined to form a cyclic structure;
R⁵, R⁶, R⁷ and R⁸ are each independently a hydrogen atom or a substituted or unsubstituted C₁ to C₂₀ hydrocarbyl group and any two of R⁵, R⁶, R⁷, and R⁸ adjacent to each other can be joined to form a cyclic structure;
R¹ and R² are a hydrogen atom or a substituted or unsubstituted C₁ to C₂₀ hydrocarbyl group; and
the dashed bonds indicate optional double bonds.

Certain embodiments of the guaiazulene-based catalysts described herein are bridged, bis-guaiazulene metallocenes more specifically represented by the formula:

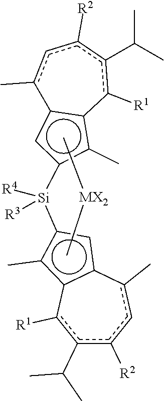

wherein:
M is a transition metal atom selected from group 4 of the Periodic Table of Elements;
each X is a univalent anionic ligand, or two Xs are joined and bound to the metal atom to form a metallocycle ring, or two Xs are joined to form a chelating ligand, a diene ligand, or an alkylidene ligand;
R³ and R⁴ are each independently a substituted or unsubstituted C₁ to C₂₀ hydrocarbyl group and can be joined to form a cyclic structure;
R¹ and R² are a hydrogen atom or a substituted or unsubstituted C₁ to C₂₀ hydrocarbyl group; and
the dashed bonds indicate optional double bonds.

Certain guaiazulene-based catalysts described herein are unbridged, bis-guaiazulene metallocenes more specifically represented by the formula:

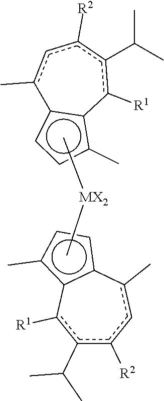

wherein:
M is a transition metal atom selected from group 4 of the Periodic Table of Elements;
each X is a univalent anionic ligand, or two Xs are joined and bound to the metal atom to form a metallocycle ring, or two Xs are joined to form a chelating ligand, a diene ligand, or an alkylidene ligand;
R¹ and R² is a hydrogen atom or a substituted or unsubstituted C₁ to C₂₀ hydrocarbyl group; and
the dashed bonds indicate optional double bonds.

In one aspect, in any embodiment of any formula described herein, each X is independently selected from the group consisting of hydrocarbyl radicals having from 1 to 20 carbon atoms (e.g., hydrides, amides, alkoxides, sulfides, phosphides, halides, dienes, amines, phosphines, ethers, and a combination thereof) and two X's may form a part of a fused ring or a ring system. For example, in an embodiment, each X is independently selected from halides and C₁ to C₅ alkyl groups (e.g., each X is a methyl group). In some embodiments, each X is independently selected from chloro, bromo, methyl, ethyl, propyl, butyl, pentyl, hexyl, heptyl, octyl, nonyl, decyl, undecyl, and dodecyl.

In yet another aspect, in any embodiment of any formula described herein, T may be represented by the formula, (R*₂G)g, where each G is C, Si, or Ge, g is 1 or 2, and each R* is, independently, hydrogen, halogen, C₁ to C₂₀ hydrocarbyl (e.g., methyl, ethyl, propyl, butyl, pentyl, hexyl, heptyl, octyl, nonyl, decyl, undecyl, or dodecyl) or a C₁ to C₂₀ substituted hydrocarbyl, and two or more R* can form a cyclic structure including aromatic, partially saturated, or saturated cyclic or fused ring system.

In another embodiment of the invention, T is a bridging group and is represented by R′₂C, R′₂Si, R′2Ge, R′₂CCR′₂, R′₂CCR′₂CR′₂, R′₂CCR′₂CR′₂CR′₂, R′C═CR′, R′C═CR′CR′₂, R′₂CCR′═CR′CR′₂, R′C═CR′CR′═CR′, R′C═CR′CR′₂CR′₂, R′₂CSiR′₂, R₂CSiR′₂CR′₂, R′₂SiCR′₂SiR′₂, R′C═CR′SiR′₂, R′₂CGeR′₂, R′₂GeGeR′₂, R′₂CGeR′₂CR′₂, R′₂GeCR′₂GeR′₂, R′₂SiGeR′₂, R′C═CR′GeR′₂, R′B, R′₂C—BR′, R′₂C—BR′—CR′₂, R′₂C—O—CR′₂, R′₂CR′₂C—O—CR′₂CR′₂, R′₂C—O—CR′₂CR′₂, R′₂C—O—CR′═CR′, R′₂C—S—CR′₂, R′₂CR′₂C—S—CR′₂CR′₂, R′₂C—S—CR′₂CR′₂, R′₂C—S—CR′═CR′, R′₂C—Se—CR′₂, R′₂CR₂C—Se—CR′₂CR′₂, R′₂C—Se—CR₂CR′₂, R′₂C—Se—CR′═CR′, R′₂C—N═CR′, R′₂C—NR′—CR′₂, R′₂C—NR′—CR′₂CR′₂, R′₂C—NR′—CR′═CR′, R′₂CR′₂C—NR′—CR′₂CR′₂, R′₂C—P═CR′, or R′₂C—PR′—CR′₂, where each R′ is, independently, hydrogen or a C₁ to C₂₀ containing hydrocarbyl (e.g., methyl, ethyl, propyl, butyl, pentyl, hexyl, heptyl, octyl, nonyl, decyl, undecyl, or dodecyl), substituted hydrocarbyl, halocarbyl, substituted halocarbyl, silylcarbyl or germylcarbyl substituent and, optionally, two or more adjacent R's may join to form a substituted or unsubstituted, saturated, partially unsaturated or aromatic, cyclic or polycyclic substituent. In some embodiments, T is a bridging group comprising carbon or silica, such as dialkylsilyl, preferably T is selected from CH₂, CH₂CH₂, C(CH₃)₂, SiMe₂, SiPh₂SiMePh, silylcyclobutyl (Si(CH₂)₃), (Ph)₂C, (p-(Et)₃SiPh)₂C, and cyclopentasilylene (Si(CH2)4) (Si(CH₂)₄).

In another aspect, in any embodiment of any formula described herein, T may be represented by the formula Ra₂J, where J is C, Si, or Ge, and each Ra is, independently, hydrogen, halogen, C₁ to C₂₀ hydrocarbyl (e.g., methyl, ethyl, propyl, butyl, pentyl, hexyl, heptyl, octyl, nonyl, decyl, undecyl, or dodecyl) or a C₁ to C₂₀ substituted hydrocarbyl, and two Ra can form a cyclic structure including aromatic, partially saturated, or saturated cyclic or fused ring system. In another aspect, in any embodiment of any formula described herein T may be CH₂, CH₂CH₂, C(CH₃)₂, SiMe₂, SiPh₂, SiMePh, Si(CH₂)₃, Si(CH₂)₄, or Si(CH₂)₅.

Certain embodiments of the metallocene compounds described herein are “asymmetric”, meaning that they have no planes of symmetry. An asymmetric catalyst is a metallocene compound comprising at least two organic ligands which differ in their chemical structure. In some embodiments, the asymmetric catalyst is a metallocene compound comprising at least two organic ligands that differ in their chemical structure and the metallocene compound is free of C₂-symmetry and/or any higher symmetry (one or more planes of symmetry).

In another aspect, in any embodiment of any formula described herein R¹ and R²—are selected from hydrogen or the group of hydrocarbyl radicals having C₁-C₂₀ such as methyl, ethyl, propyl, isopropyl, see-butyl, isobutyl, tert-butyl, pentyl, isopentyl, hexyl, and isohexyl. In another aspect, R₁ and R₂ may be selected from a group of aryl or substituted aryl, naphtyl or anthracenyl groups such as substituted phenyl, 2-methylphenyl, 4-tertbutylphenyl, 3,5-dimethylphenyl, 3,5-ditertbutylphenyl, ortho-biphenyl, meta-biphenyl, para-biphenyl, 1-naphtyl, 2-naphtyl, 2-isopropylphenyl and mesityl.

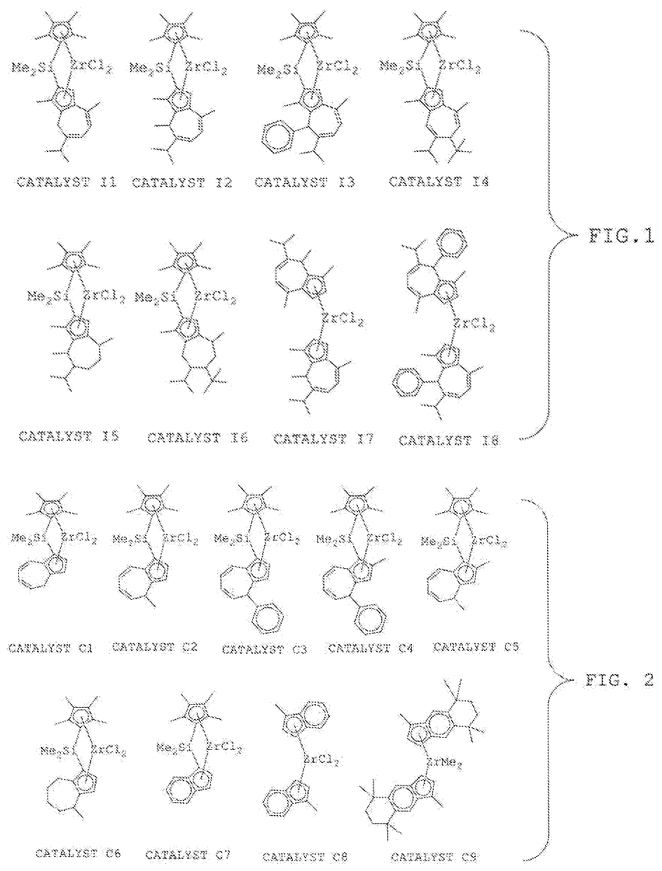

A non-limiting set of example inventive guaiazulene-based catalysts is illustrated in FIG. 1. Of the illustrated examples, catalysts I1, I2, I3, and I4 represent examples of ansa guaiazulene catalysts, catalysts I5, and I6 represent examples of ansa guaiazulene catalysts lacking the optional double bonds, and catalysts I7 and I8 represent examples of unbridged bis-guaiazulene catalysts. It should be understood that any of the selections of substituents and groups noted above can be combined in any manner and are not limiting. Other non-limiting examples include bridged bis-guaiazulene catalysts, bridged bis-guaiazulene catalysts lacking the optional double bonds in one or both guaiazulene-based ligands, unbridged bis-guaiazulene catalysts, and unbridged bis-guaiazulene catalysts lacking the optional double bonds in one or both of the guaiazulene-based ligands.

Embodiments of the inventive guaiazulene-based catalysts illustrated in FIG. 1 were synthesized and compared against a number of comparative metallocene catalyst illustrated in FIG. 2. The comparative catalysts include conventional ansa azulene derivatives (C₁, C₂, C₃, C₄, and C₅), a bridged, hydrogenated 4-Me azulenyl complex (C₆), a bridged indenyl zirconocene (C₇) and two unbridged bis-indenyl metallocenes (C₈ and C₉). It may be noted that catalysts C₈ and C₉ represent state-of-the-art olefin polymerization catalysts having “poor” comonomer incorporation. As presented in the experimental results below, it is presently recognized that certain embodiments of the inventive guaiazulene-based catalyst (e.g., I2 and I5) demonstrate low levels of comonomer incorporation that is comparable to the performance of these state-of-the-art olefin polymerization catalysts. It is presently recognized that the low comonomer incorporation enabled by certain embodiments of the inventive guaiazulene-based catalyst (e.g., I2 and I5) is highly desirable for certain applications, such as gas phase polyethylene polymerization processes involving dual catalyst systems.

### Representative Synthesis

Scheme 1 is a general synthetic scheme that demonstrates how certain embodiments of the inventive guaiazulene-based catalysts illustrated in FIG. 1 were prepared.

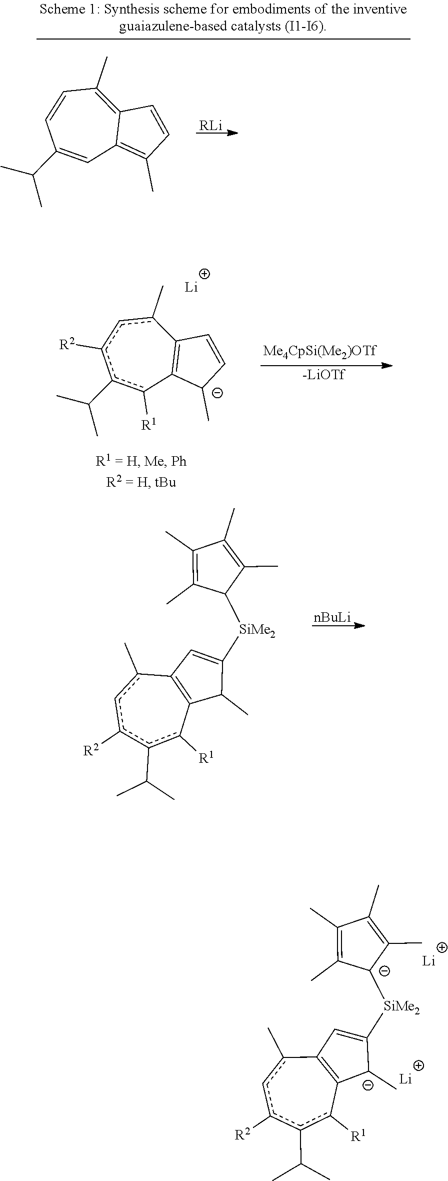

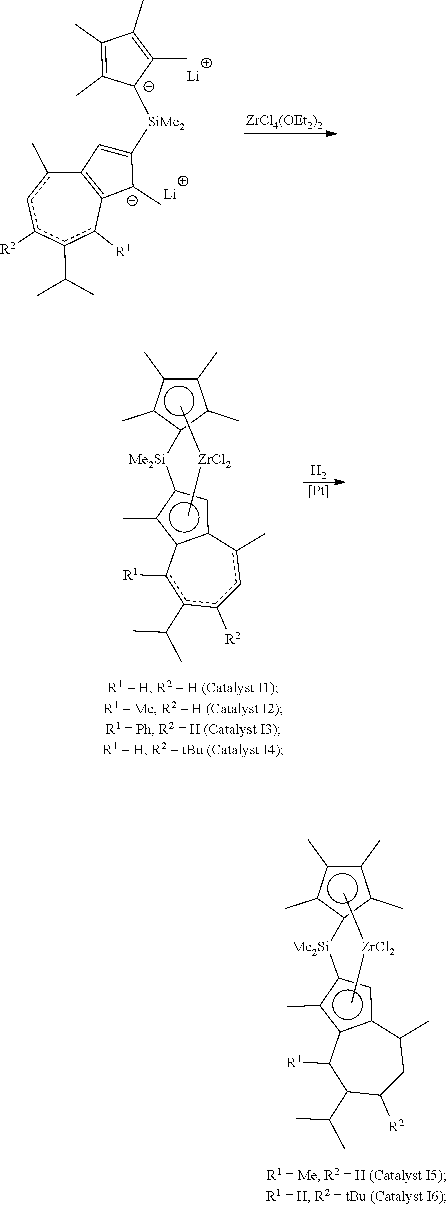

Using the first five steps of Scheme 1, several bridged, ansa metallocene embodiments of the type with Me₄Cp ligand were prepared in which R¹ is a hydrogen atom (I1), a methyl group (I2), a phenyl group (I3). When tBuLi was used in the first step, the resulting compound (I4) features tBu substituent in the R² position. Taking products I2 and I4 through the subsequent sixth step of the Scheme 1, the hydrogenation reaction reduces the double bonds of the 7-membered ring of the guaiazulene ligand to yield bridged, ansa metallocene embodiments having a saturated 7-membered ring in the backbone, wherein R¹ is a methyl group (I5) or R² is a tBu group (I6). While not expressly illustrated in Scheme 1, certain lithiated guaiazulenes produced by the first synthetic step were also combined with ZrCl₄(OEth₂)₂ to yield unbridged, bis-guaiazulene metallocene embodiments, in which R is a hydrogen atom (I7) or a phenyl group (I8).

### Activators

The terms “cocatalyst” and “activator” are used herein interchangeably and are defined to be any compound which can activate any one of the catalyst compounds described above by converting the neutral catalyst compound to a catalytically active catalyst compound cation. Non-limiting activators, for example, include alumoxanes, aluminum alkyls, ionizing activators, which may be neutral or ionic, and conventional-type cocatalysts. For various embodiments disclosed herein, the activators typically include alumoxane compounds, modified alumoxane compounds, and ionizing anion precursor compounds that abstract a reactive, σ-bound, metal ligand making the metal complex cationic and providing a charge-balancing non-coordinating or weakly coordinating anion.

In one embodiment, alumoxane activators are utilized as an activator in the catalyst composition. Alumoxanes are generally oligomeric compounds containing —Al(R¹)—O— sub-units, where R¹ is an alkyl group. Examples of alumoxanes include methylalumoxane (MAO), modified methylalumoxane (MMAO), ethylalumoxane, and isobutylalumoxane. Alkylalumoxanes and modified alkylalumoxanes are suitable as catalyst activators, particularly when the abstractable ligand is an alkyl, halide, alkoxide, or amide. Mixtures of different alumoxanes and modified alumoxanes may also be used. In some embodiments, it may be desirable to use a visually clear methylalumoxane. A cloudy or gelled alumoxane can be filtered to produce a clear solution or clear alumoxane can be decanted from the cloudy solution. A useful alumoxane is a modified methyl alumoxane (MMAO) cocatalyst type 3A (commercially available from Akzo Chemicals, Inc. under the trade name Modified Methylalumoxane type 3A).

When the activator is an alumoxane (modified or unmodified), some embodiments select the maximum amount of activator typically at up to a 5000-fold molar excess Al/M over the catalyst compound (per metal catalytic site). The minimum activator-to-catalyst-compound is a 1:1 molar ratio. In certain embodiments, the activator-to-catalyst-compound molar ratio ranges from 1:1 to 500:1, from 1:1 to 200:1, from 1:1 to 100:1, or from 1:1 to 50:1. In certain embodiments, the aluminum of the aluminoxane activator is present in molar ratios of greater than 1:100 relative to the Group 4 metal of the catalyst (e.g., greater than 1:250, or greater than 1:500).

In an alternate embodiment, little or no alumoxane is used in the polymerization processes described herein. In some embodiments, alumoxane is present at zero molar percent (e.g., 0 mol %). In other embodiments, alumoxane is present at a molar ratio of aluminum to catalyst compound transition metal less than 500:1, less than 300:1, less than 250:1, less than 100:1, or less than 1:1.

The term “non-coordinating anion” (NCA) means an anion that either does not coordinate to a cation or that is only weakly coordinated to a cation thereby remaining sufficiently labile to be displaced by a neutral Lewis base. “Compatible” non-coordinating anions are those which are not degraded to neutrality when the initially formed complex decomposes. Further, the anion will not transfer an anionic substituent or fragment to the cation to cause it to form a neutral transition metal compound and a neutral by-product from the anion. Non-coordinating anions useful in accordance with this disclosure are those that are compatible, stabilize the transition metal cation in the sense of balancing its ionic charge at +1, and yet retain sufficient lability to permit displacement during polymerization.

For example, in certain embodiments, a NCA activator may be represented by the formula: (Z)d+(Ad-). In an embodiment of this formulation, Z is (L-H)+ or a reducible Lewis Acid; L is a Lewis base; H is hydrogen; (L-H)+ is a Bronsted acid; Ad- is a non-coordinating anion having charge d-; and d is an integer from 1 to 3. In another embodiment of this formulation, Ad- is a non-coordinating anion having charge d-; d is an integer from 1 to 3; and Z is a reducible Lewis acid represented by the formula: (Ar₃C+), wherein Ar is aryl or aryl substituted with a heteroatom, a C₁ to C₄₀ hydrocarbyl, or a substituted C₁ to C₄₀ hydrocarbyl.

It is within the scope of this disclosure to use an ionizing or stoichiometric activator, neutral or ionic, such as tri (n-butyl) ammonium tetrakis(pentafluorophenyl)borate, a tris perfluorophenyl boron metalloid precursor or a tris perfluoronaphthyl boron metalloid precursor, polyhalogenated heteroborane anions, boric acid, or combination thereof. It is also within the scope of this disclosure to use neutral or ionic activators alone or in combination with alumoxane or modified alumoxane activators.

Examples of neutral stoichiometric activators include tri-substituted boron, tellurium, aluminum, gallium, and indium, or mixtures thereof. The three substituent groups are each independently selected from alkyls, alkenyls, halogens, substituted alkyls, aryls, arylhalides, alkoxy, and halides. In some embodiments, the three groups are independently selected from halogen, mono or multicyclic (including halosubstituted) aryls, alkyls, and alkenyl compounds, and mixtures thereof. This can include alkenyl groups having 1 to 20 carbon atoms, alkyl groups having 1 to 20 carbon atoms, alkoxy groups having 1 to 20 carbon atoms, and aryl groups having 3 to 20 carbon atoms (including substituted aryls). In certain embodiments, the three groups are alkyls having 1 to 4 carbon groups, phenyl, naphthyl, or mixtures thereof. In other embodiments, the three groups include halogenated (e.g., fluorinated) groups and aryl groups. For some embodiments, a neutral stoichiometric activator, such as tris perfluorophenyl boron or tris perfluoronaphthyl boron, may be used.

### Support Materials

In embodiments herein, the catalyst system may comprise an inert support material. The support material is a porous support material, for example, talc or inorganic oxides. Other support materials include zeolites, clays (e.g., silica clays, silicon oxide clay mixtures), organoclays, or any other organic or inorganic support material and the like, or mixtures thereof.

In general, the support material is an inorganic oxide in a finely divided form. Suitable inorganic oxide materials for use in metallocene catalyst systems herein include Groups 2, 4, 13, and 14 metal oxides, such as silica (SiO₂), alumina (Al₂O₃), and mixtures thereof. Other inorganic oxides that may be employed either alone or in combination with silica or alumina include magnesia, titania (TiO₂), zirconia (ZrO₂), and the like. Other suitable support materials, however, can be employed, for example, finely divided functionalized polyolefins, such as finely divided polyethylene. Examples of useful supports include, but are not limited to, magnesia, titania, zirconia, montmorillonite, phyllosilicate, zeolites, talc, clays, and the like. Also, combinations of these support materials may be used, for example, silica-chromium, silica-alumina, silica-titania, and the like. In some embodiments, support materials include Al₂O₃, ZrO₂, SiO₂, and combinations thereof, while in other embodiments, the support material includes SiO₂, Al₂O₃, or SiO₂/Al₂O₃.

It is generally desirable for the support material (e.g., an inorganic oxide) to have a surface area that ranges from 10 to 700 square meters per gram (m²/g), a pore volume that ranges from 0.1 to 4.0 cubic centimeters per gram (cc/g), and an average particle size that ranges from 5 to 500 micrometers (μm). In some embodiments, the surface area of the support material ranges from 50 to 500 m²/g, the pore volume ranges from 0.5 to 3.5 cc/g, and the average particle size ranges from 10 to 200 μm. In other embodiments, the surface area of the support material ranges from 100 to 400 m²/g, the pore volume ranges from 0.8 to 3.0 cc/g, and the average particle size ranges from 5 to 100 μm. In general, the average pore size of the support material ranges from 10 to 1000 Angstroms (Å), such as between 50 and 500 Å, or between 75 and 350 Å. In some embodiments, the support material is a high surface area, amorphous silica having a surface area of 300 m²/g and a pore volume of 1.65 cc/g.

The support material should be dry, that is, substantially or entirely free of absorbed water. Drying of the support material can be achieved by heating or calcining in a temperature range of 150° C. to 1000° C. (e.g., a temperature greater than 200° C.). For example, when the support material is silica, it is heated to at least 200° C. (e.g., between 200° C. and 850° C., or at 600° C.) for a period of time ranging from 1 minute to 100 hours (e.g., from 12 hours to 72 hours, or from 24 hours to 60 hours). In certain embodiments, the calcined support material includes reactive surface groups (e.g., at least some reactive hydroxyl (OH) groups) to produce supported catalyst systems.

The calcined support material is subsequently contacted with at least one polymerization catalyst comprising at least one metallocene compound and an activator. For example, in certain embodiments, the support material is slurried in a non-polar solvent, and the resulting slurry is subsequently contacted with a solution of a metallocene compound and an activator. In some embodiments, the slurry of the support material is first contacted with the activator for a period of time ranging from 0.1 hours to 24 hours (e.g., from 2 hours to 16 hours, or from 4 hours to 8 hours). For such embodiments, the solution of the metallocene compound is then contacted with the isolated support/activator. In certain embodiments, the supported catalyst system is generated in situ. In an alternate embodiment, the slurry of the support material is first contacted with the catalyst compound for a period of time ranging from 0.1 hours to 24 hours (e.g., from 2 hours to 16 hours, or from 4 hours to 8 hours) before the slurry of the supported metallocene compound is contacted with the activator solution.

In certain embodiments, the mixture of the metallocene, activator, and support is heated in the temperature range of 0° C. to 70° C. (e.g., between 23° C. and 60° C., at room temperature) for a contact time period. In general, the contact time period ranges from 0.1 hours to 24 hours (e.g., between 2 and 16 hours, or between 4 and 8 hours).

Suitable non-polar solvents are materials in which all of the reactants used herein (e.g., the activator and the metallocene compound) are at least partially soluble and are liquid at reaction temperatures. A non-limiting list of example non-polar solvents includes: alkanes (e.g., isopentane, hexane, n-heptane, octane, nonane, and decane), cycloalkanes (e.g., cyclohexane), aromatics (e.g., benzene, toluene, and ethylbenzene).

### Polymerization Processes

The present disclosure relates to embodiments of polymerization processes in which a monomer (such as propylene), and, optionally, a comonomer, are contacted with a catalyst system that includes at least an activator and at least one metallocene compound, as described above. The catalyst compound and activator may be combined in any order, and are typically combined prior to contacting the monomer.

Monomers useful herein include substituted or unsubstituted C₂ to C₄₀ alpha olefins, such as C₂ to C₂₀ alpha olefins or C₂ to C₁₂ alpha olefins (e.g., ethylene, propylene, butene, pentene, hexene, heptene, octene, nonene, decene, undecene, dodecene, and isomers thereof). In certain embodiments, the monomer includes propylene and optional comonomers, including one or more ethylene or C₄ to C₄₀ olefins (e.g., C₄ to C₂₀ olefins, or C₆ to C₁₂ olefins). The C₄ to C₄₀ olefin monomers may be linear, branched, or cyclic. The C₄ to C₄₀ cyclic olefins may be strained or unstrained, monocyclic or polycyclic, and may optionally include heteroatoms and/or one or more functional groups. In another embodiment, the monomer includes ethylene and optional comonomers, including one or more C₃ to C₄₀ olefins, C₄ to C₂₀ olefins, or C₆ to C₁₂ olefins. The C₃ to C₄₀ olefin monomers may be linear, branched, or cyclic. The C₃ to C₄₀ cyclic olefins may be strained or unstrained, monocyclic or polycyclic, and may optionally include heteroatoms and/or one or more functional groups.

A non-limiting list of example C₂ to C₄₀ olefin monomers and optional comonomers includes: ethylene, propylene, 1-butene, 1-pentene, 1-hexene, 1-heptene, 1-octene, nonene, 1-decene, undecene, dodecene, norbornene, norbomadiene, dicyclopentadiene, cyclopentene, cycloheptene, cyclooctene, cyclooctadiene, cyclododecene, 7-oxanorbomene, 7-oxanorbornadiene, 2-methyl-1-pentene, vinylcyclobutane, 1,5-hexadiene, 1,7-octadiene, 1,9-decadiene, substituted derivatives thereof, and isomers thereof. In certain embodiments, a non-limiting list of example C₂ to C₄₀ olefin monomers and optional comonomers includes: hexene, heptene, octene, nonene, decene, dodecene, cyclooctene, 1,5-cyclooctadiene, 1-hydroxy-4-cyclooctene, 1-acetoxy-4-cyclooctene, 5-methylcyclopentene, cyclopentene, dicyclopentadiene, norbomene, norbomadiene, and their respective homologs and derivatives. In certain embodiments, a non-limiting list of example C₂ to C₄₀ olefin monomers and optional comonomers includes norbomene, norbornadiene, and dicyclopentadiene.

Polymerization processes disclosed herein can be carried out in any manner known in the art. Any suspension, homogeneous, bulk, solution, slurry, or gas phase polymerization process known in the art can be used. Such processes can be run in a batch, semi-batch, or continuous mode. For some embodiments, homogeneous polymerization processes and slurry processes are used, wherein a homogeneous polymerization process is defined to be a process where at least 90 wt % of the product is soluble in the reaction media. In other embodiments, a bulk homogeneous polymerization process is used, wherein a bulk process is defined to be a process where monomer concentration in all feeds to the reactor is 70% or more by volume. In alternative embodiments, no substantial solvent or diluent is present or added in the reaction medium, except for the small amounts used as the carrier for the catalyst system or other additives, or amounts typically found with the monomer (e.g., propane in propylene). In another embodiment, the process is a slurry polymerization process, wherein a supported catalyst is employed and monomers are polymerized on the supported catalyst particles. For some embodiments, at least 95 wt % of polymer products derived from the supported catalyst are in granular form as solid particles (e.g., not dissolved in the diluent or solvent).

Suitable diluents/solvents for polymerization include non-coordinating, inert liquids. Examples include straight and branched-chain hydrocarbons (e.g., isobutane, butane, pentane, isopentane, hexanes, isohexane, heptane, octane, dodecane, and mixtures thereof); cyclic and alicyclic hydrocarbons (e.g., cyclohexane, cycloheptane, methylcyclohexane, methylcycloheptane, and mixtures thereof, such as Isopar™; perhalogenated hydrocarbons (e.g., perfluorinated C₄ to C₁₀ alkanes, and chlorobenzene), and aromatic and alkylsubstituted aromatic compounds (e.g., benzene, toluene, mesitylene, and xylene). Suitable solvents also include liquid olefins that may act as monomers or comonomers, including ethylene, propylene, 1-butene, 1-hexene, 1-pentene, 3-methyl-1-pentene, 4-methyl-1-pentene, 1-octene, 1-decene, and mixtures thereof. In certain embodiments, aliphatic hydrocarbon solvents (e.g., isobutane, butane, pentane, isopentane, hexanes, isohexane, heptane, octane, dodecane, and mixtures thereof) and/or cyclic and alicyclic hydrocarbons (e.g., cyclohexane, cycloheptane, methylcyclohexane, methylcycloheptane, and mixtures thereof) are used. In other embodiments, the solvent is not aromatic or includes less than 1 wt % aromatic solvents, less than 0.5 wt % aromatic solvents, or 0 wt % aromatic solvents. In an example embodiment, the feed concentration of the monomers and comonomers for the polymerization is 60 vol % solvent or less (e.g., 40 vol % or less, or 20 vol % or less), based on the total volume of the feedstream (e.g., as part of a bulk homogeneous polymerization process).

The polymerization can be run at any suitable temperature and/or pressure to obtain the desired ethylene polymers. For example, in certain embodiments, the polymerization may be performed in the temperature range from 0° C. to 300° C. (e.g., from 10° C. to 200° C., from 20° C. to 150° C., from 40° C. to 120° C., from 45° C. to 80° C.). Additionally, in certain embodiments, the polymerization is performed in the pressure range from 0.05 megapascal (MPa) to 10 MPa (e.g., from 0.07 MPa to 7 MPa, from 0.45 MPa to 6 MPa, or from 0.5 MPa to 4 MPa). In certain embodiments, the run time of the polymerization reaction is up to 300 minutes (e.g., from 5 to 250 minutes, or from 10 to 120 minutes).

### Polvolefin Products

This disclosure also relates to compositions of matter produced by the methods described herein.

The disclosed polymerization process produces olefin polymers, such as polyethylene, polypropylene homopolymers, and polypropylene copolymers. In a one embodiment, the polymers produced herein are copolymers of ethylene having from 0 to 50 mol % (e.g., from 0.5 to 50 mol %, from 1 to 30 mol %, from 5 to 10 mol %) of one or more C₃ to C₂₀ olefin comonomers (e.g., a C₃ to C₁₂ alpha-olefin, such as propylene, butene, hexene, octene, decene, or dodecene). For some embodiments, the one or more C₃ to C₂₀ olefin comonomers may be propylene, butene, hexene, or octene. In another embodiment, the polymers produced herein are copolymers of propylene having from 0 to 50 mol % (e.g., from 0.5 to 50 mol %, from 1 to 30 mol %, from 5 to 10 mol %) of one or more of C₂ or C₄ to C₂₀ olefin comonomer (e.g., a C₄ to C₁₂ alpha-olefin, such as ethylene, butene, hexene, octene, decene, or dodecene). For some embodiments, the one or more C₂ or C₄ to C₂₀ olefin comonomer may be ethylene, butene, hexene, or octene. For certain embodiments, the propylene polymers produced may be isotactic polypropylene, atactic polypropylene having random, block, or impact copolymers.

In some embodiments, the olefin polymer products are homopolymers or copolymers having a mean molecular weight (Mw) from 1,000 grams per mole (g/mol) to 1,000,000 g/mol, from 5,000 g/mol to 500,000 g/mol, or from 10,000 g/mol to 250,000 g/mol, as measured by gel permeation chromatography. In some embodiments, these homopolymers or copolymers have a Mw distribution with polydispersity index less than 10, less than 6, or less than 3. In some embodiments, these homopolymers or copolymers have a melting point (Tm) less than 135° C. In some embodiments, a copolymer product has a comonomer content from 0.1 wt % to 50 wt % (e.g., from 1 wt % to 35 wt %, from 2 to 20 wt %, or from 3 wt % to 10 wt %).

### Additional Embodiments

The following embodiments are offered as further description of the present disclosure.

Embodiment 1. A catalyst compound represented by the formula:

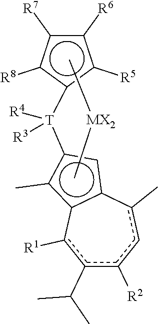

wherein M is a transition metal atom selected from group 4 of the Periodic Table of Elements; each X is a univalent anionic ligand, or two Xs are joined and bound to the transition metal atom to form a metallocycle ring, or two Xs are joined to form a chelating ligand, a diene ligand, or an alkylidene ligand; T is an optional bridging group that includes R³ and R⁴, wherein R³ and R⁴ are each independently a substituted or unsubstituted C₁ to C₂₀ hydrocarbyl group and can be joined to form a cyclic structure; R⁵, R⁶, R⁷ and R⁸ are each independently a hydrogen atom or a substituted or unsubstituted C₁ to C₂₀ hydrocarbyl group and any two of R⁵, R⁶, R⁷, and R⁸ adjacent to each other can be joined to form a cyclic structure; R¹ and R² are a hydrogen atom or a substituted or unsubstituted C₁ to C₂₀ hydrocarbyl group; and the dashed bonds indicate optional double bonds.

Embodiment 2. The catalyst compound of embodiment 1, wherein R¹ and R² are a hydrogen atom, a methyl, ethyl, isopropyl, n-propyl, n-butyl, isobutyl, tertbutyl, n-pentyl, neopentyl, isopentyl, n-hexyl, isohexyl group, or a substituted or unsubstituted phenyl, napthyl or anthracenyl group.

Embodiment 3. The catalyst compound according to any of Embodiments 1 or 2, wherein the optional bridging group T is present and the catalyst compound is a bridged catalyst compound.

Embodiment 4. The catalyst compound according to any of Embodiments 1-3, wherein each of R⁵, R⁶, R⁷ and R⁸ is independently a methyl group and the catalyst compound is a bridged, ansa guaiazulene catalyst compound.

Embodiment 5. The catalyst compound of Embodiment 4, wherein the optional double bonds are not present.

Embodiment 6. The catalyst compound according to any of Embodiments 1 or 2, wherein R⁵ and R⁸ are a hydrogen atom or a methyl group and R⁶ and R⁷ are joined to form a 7-member ring, and the catalyst compound is a bis-guaiazulene catalyst compound.

Embodiment 7. The catalyst compound of Embodiment 6, wherein the optional bridging group T is not present and the catalyst compound is an unbridged, bis-guaiazulene catalyst compound.

Embodiment 8. The catalyst compound of Embodiment 7, wherein the optional double bonds are not present.

Embodiment 9. A catalyst system comprising the catalyst compound according to any of Embodiments 1 or 2 and an activator.

Embodiment 10. The catalyst system of Embodiment 9, wherein the activator is either aluminoxane or salts of non-coordinating (NCA) anions.

Embodiment 11. The catalyst system of Embodiment 10, wherein the NCA activator is represented by the formula: (Z)d+(Ad-), wherein Z is (L-H)+ or a reducible Lewis Acid; L is a Lewis base; H is hydrogen; (L-H)+ is a Bronsted acid; Ad- is a non-coordinating anion having charge d-; and d is an integer from 1 to 3.

Embodiment 12. The catalyst system of Embodiment 10, wherein the NCA activator is represented by the formula: (Z)d+(Ad-), wherein Ad- is a non-coordinating anion having charge d-; d is an integer from 1 to 3; and Z is a reducible Lewis acid represented by the formula: (Ar₃C+), wherein Ar is aryl or aryl substituted with a heteroatom, a C₁ to C₄₀ hydrocarbyl, or a substituted C₁ to C₄₀ hydrocarbyl.

Embodiment 13. The catalyst system of according to any of Embodiments 9 or 10, wherein a molar ratio of aluminum of the aluminoxane activator to the transition metal of the catalyst compound in the catalyst system is greater than 1:100, greater than 1:250, or greater than 1:500.

Embodiment 14. The catalyst system according to any of Embodiments 9, 10, or 13, further comprising a support material, wherein the support material comprises alumina (Al₂O₃), zirconia (ZrO₂), silica (SiO₂), SiO₂/Al₂O₃, SiO₂/titania (TiO₂), silica clay, silicon oxide/clay, or mixtures thereof.

Embodiment 15. A process to prepare an olefin homopolymer or copolymer by: introducing ethylene or propylene and optionally one or more C₄ to C₄₀ olefin comonomers, and a catalyst system of Embodiment 9, and optionally hydrogen into a reactor at a reactor pressure from 0.07 megapascal (MPa) to 7 MPa and a reactor temperature from 20 degrees Celsius (° C.) to 150° C.; and obtaining the olefin homopolymer or copolymer.

Embodiment 16. The process of Embodiment 15 wherein the C₄ to C₄₀ comonomers consists of 1-butene, 1-pentene, 1-hexene, 2-methyl-1-pentene, vinylcyclobutane, 1-heptene, 1-octene, 1-decene, 1,5-hexadiene, 1,7-octadiene, and 1,9-decadiene.

Embodiment 17. The process according to any of Embodiments 15 or 16, wherein the olefin homopolymer or copolymer has a mean molecular weight (Mw) from 1,000 grams per mole (g/mol) to 1,000,000 g/mol, from 5,000 g/mol to 500,000 g/mol, or from 10,000 g/mol to 250,000 g/mol, as measured by gel permeation chromatography.

Embodiment 18. The process according to any of Embodiments 15-17, wherein the olefin homopolymer or copolymer has a Mw distribution with polydispersity index less than 10, less than 6, or less than 3.

Embodiment 19. The process according to any of Embodiments 15-18, wherein the olefin homopolymer or copolymer has a melting point of less than 135° C.

Embodiment 20. The process of according to any of Embodiments 15-19, wherein the olefin copolymer is obtained having a comonomer content from 0.1 weight percent (wt %) to 50 wt %, from 1 wt % to 35 wt %, from 2 to 20 wt %, or from 3 wt % to 10 wt %.

### EXAMPLES

Provided herein are example synthetic procedures that were used to prepare the remaining comparative catalysts (i.e., C₁-C₆), as well as example synthetic procedures used to prepare embodiments of the inventive catalysts (i.e., I1-I8) discussed above. Catalysts C₇, C₈ and C₉ were obtained from commercial sources or prepared as previously reported in patent literature. Each of these synthetic procedures include at least proton Nuclear Magnetic Resonance (¹H NMR) spectrum characterization data collected using a 400 megahertz (MHz) spectrometer in the indicated deuterated solvent. Also provided herein are example polymerization procedures performed using these comparative and inventive catalysts, as well as example procedures that were used to perform Differential Scanning Calorimetry (DSC) and Rapid Gel Permeation Chromatography (GPC) during characterization of the olefin polymer products of each of the polymerizations.

### Synthesis of Catalyst C1

To a precooled, stirring solution of dimethyl(2,3,4,5-tetramethylcyclopentadienyl)silyl trifluoromethanesulfonate (2.351 g, 7.16 mmol) in diethyl ether (40 mL), a suspension of lithium 1,4-dihydroazulenide (0.976 g, 7.17 mmol) in diethyl ether (10 mL) was added. The reaction was stirred at room temperature for 3 hours. The reaction was concentrated under a stream of nitrogen and then under high vacuum. The residue was extracted with pentane (20 mL, then 2×10 mL) and filtered over Celite. The combined pentane extracts were concentrated under a stream of nitrogen and then under high vacuum to afford the product as a light amber oil (1.723 g, 78% yield, mixture of regioisomers). ¹H NMR (400 MHz, C₆D₆): δ 6.84-6.20 (m, 4H), 6.12-6.01 (m, 1H), 5.39-5.05 (m, 1H), 3.70-3.43 (m, 1H), 2.97-2.65 (m, 2H), 1.97-1.77 (m, 12H), −0.04-−0.17 (m, 3H), −0.22-−0.36 (m, 3H).

To a precooled, stirring solution of (1,4-dihydroazulenyl)dimethyl(2,3,4,5-tetramethylcyclopenta-dienyl)silane (1.723 g, 5.58 mmol) in diethyl ether (50 mL), nBuLi (6.80 mL, 1.64 M in hexane, 11.2 mmol, 2 equivalents (equiv.)) was added. The reaction was stirred at room temperature for 17 hours. The reaction was concentrated under a stream of nitrogen. The residue was washed with diethyl ether (10 mL, then 5 mL) and filtered over a plastic, fritted funnel. The filtered solid was collected and concentrated under high vacuum to afford the product as a grey-tan solid. To a precooled, stirring suspension of this solid in diethyl ether (50 mL), zirconium chloride (1.305 g, 5.60 mmol, 1 equiv.) and toluene (2 mL) were added. The reaction was stirred at room temperature for 6 hours. The reaction was concentrated under a stream of nitrogen and then under high vacuum. The residue was extracted with dichloromethane (30 mL, then 10 mL) and filtered over Celite. The combined dichloromethane extracts were concentrated under a stream of nitrogen and then under high vacuum. The residue was washed with pentane and filtered over a plastic, fritted funnel. The filtered solid was collected and concentrated under high vacuum to afford the product as a tan solid (1.402 g, 53% yield; mixture of four isomers). ¹H NMR (400 MHz, CD₂Cl₂) integrated as one isomer: δ 6.91-5.24 (m, 6H), 3.69-2.75 (m, 2H), 2.12-1.81 (m, 12H), 1.02-0.74 (m, 6H).

### Synthesis of Catalyst C2

To a precooled, stirring solution of dimethyl(2,3,4,5-tetramethylcyclopentadienyl)silyl trifluoromethanesulfonate (2.389 g, 7.27 mmol) in diethyl ether (40 mL), a suspension of lithium 4-methyl-1,4-dihydroazulenide (1.096 g, 7.30 mmol, 1 equiv.) in diethyl ether (10 mL) was added. The reaction was stirred at room temperature for 3.5 hours. The reaction was concentrated under a stream of nitrogen and then under high vacuum. The residue was extracted with pentane (20 mL, then 2×10 mL) and filtered over Celite. The combined pentane extracts were concentrated under a stream of nitrogen and then under high vacuum to afford the product as a light amber oil (1.806 g, 77% yield, mixture of two isomers). ¹H NMR (400 MHz, C₆D₆): δ 6.91-5.91 (m, 12H), 5.32-5.20 (m, 2H), 3.75-3.50 (m, 2H), 2.96-2.66 (m, 4H), 1.92 (s, 12H), 1.82 (s, 12H), 1.33 (d, 3H, J=7.2 Hz), 1.23 (d, 3H, J=7.1 Hz), −0.08 (s, 3H), −0.12 (s, 3H), −0.27 (s, 3H), −0.32 (s, 3H).

To a precooled, stirring solution of dimethyl(4-methyl-1,4-dihydroazulenyl)(2,3,4,5-tetramethylcyclopenta-dienyl)silane (1.806 g, 5.60 mmol, 1 equiv.) in diethyl ether (50 mL), n-butyllithium (n-BuLi) (6.8 mL, 1.64 M in hexane, 11 mmol, 2 equiv.) was added. The reaction was stirred at room temperature for 1.5 hours. Then, zirconium chloride (1.293 g, 5.55 mmol, 1 equiv.) was added. The reaction was stirred at room temperature overnight. The reaction was concentrated under a stream of nitrogen and then under high vacuum. The residue was extracted with dichloromethane and filtered over Celite. The dichloromethane extract was concentrated under a stream of nitrogen and then under high vacuum to afford the product as a yellow solid (2.643 g, 98% yield, 1:5.9:6.7:8.2 mixture of four isomers). ¹H NMR (400 MHz, CD₂Cl₂): δ 6.91-5.40 (m, 24H), 3.83-3.74 (m, 1H), 3.70-3.59 (m, 1H), 3.43-3.33 (m, 1H), 3.27-3.14 (m, 1H), 2.12-1.89 (m, 48H), 1.63 (d, 3H, J=7.2 Hz), 1.60 (d, 3H, J=7.2 Hz), 1.54 (d, 3H, J=7.2 Hz), 1.40 (d, 3H, J=7.1 Hz), 1.02 (s, 3H), 1.00 (s, 3H), 0.91 (s, 3H), 0.88 (s, 6H), 0.86 (s, 3H), 0.85 (s, 3H), 0.83 (s, 3H).

### Synthesis of Catalyst C₃

To a precooled, stirring solution of dimethyl(2,3,4,5-tetramethylcyclopentadienyl)silyl trifluoromethanesulfonate (1.547 g, 4.71 mmol) in diethyl ether (40 mL), a suspension of lithium 4-phenyl-1,4-dihydroazulenide (1.00 g, 4.71 mmol, 1 equiv.) in diethyl ether (10 mL) was added. The reaction was stirred at room temperature for 2 hours. The reaction was concentrated under a stream of nitrogen and then under high vacuum. The residue was extracted with pentane (40 mL, then 10 mL) and filtered over Celite. The combined pentane extracts were concentrated under a stream of nitrogen and then under high vacuum to afford the product as a green-brown oil (1.477 g, 81% yield, mixture of two isomers). ¹H NMR (400 MHz, C₆D₆): δ7.38-6.98 (m, 10H), 6.80-6.70 (m, 2H), 6.52-6.39 (m, 2H), 6.34-6.07 (m, 6H), 5.77-5.54 (m, 2H), 4.13-3.97 (m, 2H), 3.67-3.51 (m, 2H), 2.95-2.73 (m, 2H), 1.90 (s, 12H), 1.80 (s, 12H), −0.08 (s, 3H), −0.16 (s, 3H), −0.29 (s, 3H), −0.38 (s, 3H).

To a precooled, stirring solution of dimethyl(4-phenyl-1,4-dihydroazulenyl)(2,3,4,5-tetramethylcyclopenta-dienyl)silane (1.477 g, 3.84 mmol) in diethyl ether (50 mL), n-BuLi (4.7 mL, 1.64 M in hexane, 7.7 mmol, 2 equiv.) was added. The reaction was stirred at room temperature for 1.5 hours. The reaction was concentrated under a stream of nitrogen and then under high vacuum. The residue was stirred in pentane (20 mL). The resulting suspension was filtered over a plastic, fritted funnel. The filtered solid was collected and concentrated under high vacuum to give a brown-red solid. To a precooled, stirring solution of this solid in diethyl ether (50 mL), zirconium chloride (0.895 g, 3.84 mmol, 1 equiv.) and toluene (2 mL) were added. The reaction was stirred at room temperature overnight. The reaction was concentrated under a stream of nitrogen and then under high vacuum. The residue was extracted with dichloromethane and filtered over Celite. The filtrate was concentrated under a stream of nitrogen and then under high vacuum to afford the product as a beige solid (1.903 g, 90% yield, 1:1.3 ratio of isomers). ¹H NMR (400 MHz, CD₂Cl₂): δ7.47-7.22 (m, 10H), 6.61 (d, 1H, J=11.4 Hz), 6.54 (d, 1H, J=11.4 Hz), 6.24 (dd, 1H, J=11.5, 6.0 Hz), 6.19 (dd, 1H, J=11.3, 6.8 Hz), 6.03-5.78 (m, 5H), 5.63 (d, 1H, J=3.1 Hz), 5.53 (d, 1H, J=3.0 Hz), 5.11 (d, 1H, J=3.3 Hz), 4.97 (dd, 1H, J=4.5, 2.3 Hz), 4.89 (d, 1H, J=6.5 Hz), 2.07 (s, 3H), 2.06 (s, 3H), 2.05 (s, 3H), 2.04 (s, 3H), 1.95 (s, 3H), 1.92 (s, 6H), 1.79 (s, 3H), 0.98 (s, 3H), 0.85 (s, 3H), 0.79 (s, 3H), 0.74 (s, 3H).

### Synthesis of Catalyst C₄

To an ink blue sol of 5.00 g 2-Me-azulene in 50 mL Et₂O was added dropwise a sol of 3.45 g PhLi in 15 mL Et₂O. Upon completion, the reaction mixture changed to amber-orange with gray precipitant at end of addition. The reaction mixture was stirred for 1 hour, then concentrated to 30 mL under nitrogen and cooled to −35° C. After 3 days, the tan solid was filtered, washed with pentane (20 mL) and dried in vacuo. Yield 7.3 g (93%) tan powder. ¹H NMR (THF-d8) shows clean Li(2-Me-4-PhH2Azulenide), which was immediately used in the next step.

To a cold solution of Me₄CpSiMe₂OTf (1.5 g, 4.57 mmol) was slowly added (2-methyl-4-phenyl-1,4-dihydroazulen-1-yl)lithium (1.03 g, 4.57 mmol) as a solid. The mixture was allowed to react overnight. After 18 hours, solvent was removed in vacuo and the residue was extracted with pentane and filtered over Celite. Solvent was removed again to afford a yellow oil, which appears of reasonable purity (1.8 g isolated, 99% yield). Azulene was manifested as two isomers. ¹H NMR (400 MHz, Benzene d6) δ 7.40 (m, 2H) 7.28 (m, 2H), 7.18 (m, 1H) 6.86 (s, 1H), 6.29 (s, 2H), 5.98 (m 1H), 5.67 (m, 1H), 4.06 (m, 1H), 3.55 (m, 1H), 3.14 (m, 1H) 2.18-1.84 (m, 15H), 0.09-−0.24 (m, 6H).

n-BuLi (3.65 mL, 2.7 M in hexane) was slowly added to a pre-cooled diethylether solution of ligand (1.8 g, 4.8 mmol). The mixture was then allowed to warm up and was stirred for 5 hours. After 5 hours, solvent was removed in vacuo and the residue was suspended in pentane and stirred for 30 minutes. The mixture was filtered to give a dark red powder, which appear reasonably clean by ¹H NMR and was used without further purification in the next step (2.1 g isolated, quantitative yield). The molecule was isolated as 0.35 equiv. ether adduct, as two isomers in essentially quantitative yield. ¹H NMR (400 MHz, THF-d8) δ 7.44-6.84 (m, 6H), 5.82 (m, 1H), 5.43 (m, 1H), 4.96 (m, 1H), 4.29 (m, 1H), 2.15-1.93 (overlapping s, 15H), 0.35 (two s, 6H).

Solid dilithium ligand (2.0 g, 4.6 mmol) was slowly added to a pre-cooled stirring slurry of 1.75 g of ZrCl₄(OEt₂)₂ in diethylether. The reaction mixture was allowed to warm up to room temperature and was stirred for 2 days. After 2 days, the dark brown mixture was concentrated in vacuo to afford brown solids. The solids were extracted with methylene chloride (2×20 mL) and filtered over Celite and concentrated. Addition of pentane precipitated beige solids, which were collected on a filter frit and dried in vacuo to afford final product in reasonable yield and purity.

Solid ligand was slowly added to a pre-cooled stirring slurry of ZrCl₄(OEt₂)₂ in diethylether. The reaction mixture was allowed to warm up to room temperature and was stirred for 2 days. After 2 days, the dark brown mixture was concentrated in vacuo to afford brown solids. The solids were extracted with methylene chloride (2×20 mL) and filtered over Celite and concentrated. Addition of pentane precipitated beige solids, which were collected on a filter frit and dried in vacuo to afford final product in reasonable yield and purity (1.4 g isolated, 55% yield). ¹H NMR (400 MHz, Methylene Chloride-d2) δ 7.49 (m, 2H), 7.40 (m, 2H), 7.32 (m, 1H), 6.79 (d, 1H), 6.14 (m, 1H), 5.96 (m, 1H), 5.88 (m, 2H), 4.97 (m, 1H), 2.15 (s, 3H), 2.10 (s, 3H) 2.07 (s, 3H), 2.04 (s, 3H), 2.02 (s, 3H), 1.04 (s, 3H), 1.02 (s, 3H).

### Synthesis of Catalyst C₅

To a cold solution of Me₄CpSiMe₂OTf (1.5 g, 4.57 mmol) was slowly added (2,4-dimethyl-1,4-dihydroazulen-1-yl)lithium (0.75 g, 4.57 mmol) as a solid. The mixture was allowed to react overnight. After 18 hours, solvent was removed in vacuo and the residue was extracted with pentane and filtered over Celite. Solvent was removed again to afford a yellow oil, which appears of reasonable purity (1.51 g isolated, 98% yield). Final product was manifested as two isomers. ¹H NMR (400 MHz, Benzene-d6) δ 6.83 (m, 1H), 6.29 (m, 1H), 6.11 (m, 2H), 5.24 (m, 1H), 3.47 (m, 1H), 3.15 (m, 1H), 2.78 (m, 1H), 2.02 (m, 3H), 1.91 (two s, 6H), 1.81 (two s, 6H), 1.27 (m, 3H), −0.12-−0.30 (4 singlets, 6H).

n-BuLi (3.31 mL, 2.7 M in hexane) was slowly added to a stirred ether solution of ligand (1.5 g, 4.7 mmol) at −35° C. The reaction mixture turned dark red as it warmed up and became slightly hazy. It was allowed to stir overnight. After 18 hours, solvent was removed in vacuo and the residue was suspended in 30 mL of pentane and stirred for 30 minutes. The resulting precipitate was collected on a glass frit and was dried in vacuo to afford the final product as orange powder in good yield (1.45 g, 3.6 mmol, isolated as 0.33 equiv of Et₂O and 0.5 equiv. residual pentane) and reasonable purity. ¹H NMR (400 MHz, THF-d8) δ 7.23 (m, 1H), 5.68 (m, 1H), 5.42 (m, 2H), 5.07 (m, 1H), 3.03-2.85 (m, 1H), 2.23 (s, 3H), 2.08 (s, 6H), 1.95 (s, 6H), 1.31 (d, 3H), 0.49 (s, 6H).

To a stirring solution of lithium dimethyl(2,4-dimethyl-1,4-dihydroazulenidyl)(2,3,4,5-tetramethylcyclopenta-dienyl)silane (0.904 g, 2.59 mmol, 1.01 equiv.) in diethyl ether (50 mL), zirconium chloride (0.598 g, 2.57 mmol) and toluene (2 mL) were added. The reaction was stirred at room temperature for 16 hours. The reaction was concentrated under a stream of nitrogen and then under high vacuum. The residue was extracted with dichloromethane (3×20 mL) and filtered over Celite. The combined dichloromethane extract was concentrated under a stream of nitrogen and then under high vacuum to give an orange-yellow foam. The foam was stirred in pentane (30 mL). The resulting suspension was filtered over a plastic, fritted funnel. The filtered solid was collected and concentrated under high vacuum to afford the product as a yellow solid (0.858 g, 67% yield, 5:1 mixture of isomers). ¹H NMR (400 MHz, CD₂Cl₂), major isomer: δ 6.77 (d, 1H, J=11.5 Hz), 6.36 (s, 1H), 6.13 (ddd, 1H, J=11.6, 5.6, 0.9 Hz), 5.83 (ddd, 1H, J=10.1, 5.6, 2.3 Hz), 5.41 (ddd, 1H, J=10.1, 4.7, 0.9 Hz), 3.42-3.34 (m, 1H), 2.16 (s, 3H), 2.04 (s, 3H), 2.02 (s, 3H), 2.00 (s, 3H), 1.99 (s, 3H), 1.47 (d, 3H, J=7.1 Hz). 0.992 (s, 3H), 0.989 (s, 3H).

### Synthesis of Catalyst C₆

A stirring mixture of dimethylsilyl (4-methyl-1,4-dihydroazulenyl) (2,3,4,5-tetramethylcyclopentadienyl) zirconium dichloride (1.014 g, 2.10 mmol) and platinum (IV) oxide (0.052 g, 0.23 mmol, 11 mol %) in dichloromethane (10 mL) in a pressure vessel was pressurized with hydrogen gas to 50 pounds per square inch (psi). The reaction was stirred at room temperature for 27 hours. The reaction was filtered over Celite. The filtrate was concentrated under a stream of nitrogen and then under high vacuum. The residue was extracted with hexane (10 mL, then 5 mL) and filtered over Celite. The filtrate was concentrated under a stream of nitrogen to half volume and then cooled to −35° C. overnight. Precipitation occurred, and the supernatant was decanted off while still cold. The precipitate was concentrated under high vacuum to afford the product as a pale yellow solid (0.117 g, 11% yield, mixture of four isomers). ¹H NMR (400 MHz, C₆D₆): δ6.93 (d, 1H, J=3.1 Hz), 6.87 (d, 1H, J=3.1 Hz), 5.45 (d, 1H, J=3.1 Hz), 5.32-5.28 (m, 3H), 5.20 (d, 1H, J=3.0 Hz), 5.13 (d, 1H, J=3.1 Hz), 3.47-2.34 (m, 12H), 2.23-0.98 (m, 84H), 0.58-0.36 (m, 24H).

### Synthesis of Catalyst I1

To a stirring suspension of lithium 5-isopropyl-3,8-dimethyl-1,4-dihydroazulenide (0.363 g, 1.76 mmol, 1.01 equiv.) in diethyl ether (30 mL), a solution of dimethyl(2,3,4,5-tetramethylcyclopentadienyl)silyl trifluoromethanesulfonate (0.570 g, 1.74 mmol) in diethyl ether (10 mL) was added. The reaction was stirred at room temperature for 4 hours. The reaction was concentrated under a stream of nitrogen and then under high vacuum. The residue was extracted with pentane and filtered over Celite. The filtrate was concentrated under a stream of nitrogen and then under high vacuum to afford the product as an orange-yellow oil (0.517 g, 78% yield). ¹H NMR (400 MHz, C₆D₆): δ 6.33-6.22 (br s, 1H), 6.22-6.12 (br s, 1H), 5.77 (d, 1H, J=5.8 Hz), 3.72-3.58 (br s, 1H), 3.13 (dd, 1H, J=13.5, 1.6 Hz), 2.90-2.82 (br s, 1H), 2.54-2.34 (m, 2H), 2.09-2.00 (m, 9H), 1.93 (s, 3H), 1.86 (s, 3H), 1.83 (s, 3H), 1.09 (dd, 6H, J=6.8, 1.0 Hz), 0.02-−0.13 (br s, 3H), −0.30-−0.59 (br s, 3H).

To a precooled, stirring solution of (5-isopropyl-3,8-dimethyl-2,4-dihydroazulenyl)dimethyl(2,3,4,5-tetramethylcyclopentadienyl)silane (0.517 g, 1.37 mmol) in diethyl ether (50 mL), n-BuLi (1.70 mL, 1.64 M in hexane, 2.79 mmol, 2.04 equiv.) was added. The reaction was stirred at room temperature for 2.5 hours. The reaction was concentrated under a stream of nitrogen and then under high vacuum. The residue was washed with pentane. The pentane-washed solid was concentrated under high vacuum to afford the product as a light tan solid (0.519 g, 97% yield). ¹H NMR (400 MHz, C₄D₈O): δ 5.99 (s, 1H), 5.45 (d, 1H, J=6.2 Hz), 5.29 (dd, 1H, J=6.3, 1.3 Hz), 2.91-2.83 (br s, 2H), 2.36 (hept, 1H, J=7.1 Hz), 2.17 (s, 3H), 2.10 (s, 3H), 2.08 (s, 6H), 1.91 (s, 6H), 1.06 (d, 6H, J=6.8 Hz), 0.47-0.35 (br s, 6H).

To a precooled, stirring solution of lithium (5-isopropyl-3,8-dimethyl-2,4-dihydroazulenidyl)-dimethyl(2,3,4,5-tetramethylcyclopentadienyl)silane (0.519 g, 1.33 mmol) in diethyl ether (50 mL), zirconium chloride (0.314 g, 1.35 mmol, 1.01 equiv.) and toluene (1 mL) were added. The reaction was stirred at room temperature for 16 hours. The reaction was concentrated under a stream of nitrogen and then under high vacuum. The residue was extracted with dichloromethane (20 mL, then 10 mL) and filtered over Celite. The combined dichloromethane extracts were concentrated under a stream of nitrogen and then under high vacuum to give a dark blue-green solid. The solid was stirred in pentane (30 mL). The resulting suspension was filtered over a plastic, fritted funnel. The filtered solid was collected and concentrated under high vacuum to give a dark grey-blue solid. This solid was stirred in diethyl ether (4 mL), and the resulting suspension was filtered over a plastic, fritted funnel, washing further with additional diethyl ether (1 mL). The filtered solid was collected and concentrated under high vacuum to afford the product as a pale purple solid (0.332 g, 46% yield). ¹H NMR (400 MHz, CD₂Cl₂): δ 6.09 (dd, 1H, J=6.8, 1.4 Hz), 5.72 (d, 1H, J=6.9 Hz), 5.54 (s, 1H), 3.39 (dd, 1H, J=14.8, 1.4 Hz), 2.93 (dd, 1H, J=14.5, 1.6 Hz), 2.46 (hept, 1H, J=6.6 Hz), 2.10 (s, 3H), 2.032 (s, 3H), 2.026 (s, 3H), 2.00 (s, 3H), 2.001-1.989 (m, 3H), 1.986 (s, 3H), 1.07 (d, 3H, J=6.0 Hz), 1.06 (d, 3H, J=6.1 Hz), 0.92 (s, 3H), 0.87 (s, 3H).

### Synthesis of Catalyst I2

To an ink blue sol of 3.3 g azulene in 50 mL Et₂O was added dropwise a solution of MeLi. The mixture was stirred for 5 hours at room temperature. After 18 hours, the reaction mixture was red with white precipitate. The solution was filtered, and solid was collected and washed with additional ether and pentane. ¹H NMR (THF-d8) shows desired product (1.54 g isolated, 44% yield). ¹H NMR (400 MHz, THF-d8) δ 5.73 (m, 1H), 5.64 (m, 1H), 5.53 (m, 1H), 5.32 (m, 1H), 3.55 (q, 1H), 2.48 (m, 1H), 2.13 (s, 6H), 1.14 (m, 6H), 0.88 (d, 3H).

Solid (5-isopropyl-3,4,8-trimethyl-2,4-dihydroazulen-1-yl)lithium (1.2 g, 5.3 mmol) was added to a cold solution of Me₄Cp(OTf)SiMe₂ (1.73 g, 5.3 mmol) in diethylether. The mixture was allowed to stir for 6 hours at room temperature. After 6 hours, the resulting blue mixture was concentrated in vacuo. The solids were extracted with pentane, filtered over Celite and concentrated to afford final product as viscous blue oil. The oil appears reasonable for proposed structure based on ¹H NMR (2.0 g isolated, 97% yield). ¹H NMR (400 MHz, Benzene-d6) δ 6.02 (m, 1H), 5.80 (m, 1H), 3.44 (m, 1H), 2.85 (m, 1H), 2.44 (m, 1H), 2.27-1.58 (m, 21H), 1.09 (m, 9H), −0.26 (two s, 6H).

n-BuLi (3.9 mL, 2.7 M in hexane) was slowly added to a pre-cooled solution of ligand (2.0 g, 5.1 mmol) in diethylether. The reaction mixture rapidly changed from a blue color to an orange color. The mixture was stirred for 1 hour at room temperature. After 1 hour, the mixture was concentrated in vacuo to give orange solids. Excess pentane was added and the solids were stirred for 30 minutes. After 30 minutes, the solids were filtered, washed with additional pentane and dried in vacuo to afford final product in good yield and purity along with 0.33 equiv. of residual diethylether (1.95 g isolated, 81% yield). ¹H NMR (400 MHz, THF-d8) δ 6.09 (m, 1H), 5.52 (m, 1H), 5.28 (m, 1H), 3.52 (m, 1H), 1.26 (m, 2H) 2.22 (m, 3H) 2.14 (s, 3H) 2.10 (s, 3H) 2.04 (s, 3H) 1.94 (s, 6H) 1.12 (m, 6H) 0.82 (m, 3H) 0.46 (m, 6H).

Solid delithiated ligand (1.93 g, 4.1 mmol) was added to a stirred slurry of 1.6 g of ZrCl₄(OEt₂)₂ in 60 mL of diethylether. The reaction mixture was allowed to warm up to room temperature and was stirred overnight. After 18 hours, the greenish-yellow mixture was concentrated in vacuo to afford foamy solids. The solid was extracted with methylene chloride (2×20 mL) and filtered over Celite and concentrated in vacuo. Addition of excess pentane resulted in precipitation of tan solid. The solid was stirred for 1 hour in pentane and was then filtered and dried in vacuo. ¹H NMR indicates a very clean product manifested as roughly 6:4 ratio of diastereomers (1.1 g, 48% yield). ¹H NMR (400 MHz, Methylene Chloride-d2) δ 6.10 (m, 1H, azulene CH, both isomers), 5.69 (m, 1H, azulene both isomers), 5.66 (s, 1H, CH, isomer 2) 5.30 (s, 1H, CH, isomer 1), 3.71 (m, 1H, isomer 2) 3.50 (m, 1H, isomer 1), 2.61 (m, 1H, iPr-H, isomer 1), 2.47 (m, 1H, iPr-H, isomer 2) 2.15 (s, 3H, isomer 2), 2.13 (s, 3H, isomer 2), 2.12 (s, 3H isomer 1), 2.08 (s, 3H, isomer 2), 2.06 (s, 3H, isomer 2), 2.04 (s, 3H, isomer 1), 2.03 (s, 3H, isomer 1), 2.02 (s, 3H, isomer 1), 1.97 (s, 3H, isomer 1), 1.91 (s, 3H isomer 1), 1.33 (s, 3H, isomer 2), 1.15 (d, 3H).

### Synthesis of Catalyst I3

To an ink blue sol of 3.46 g azulene in 50 mL Et₂O was added dropwise a solution of 1.47 g PhLi in 15 mL Et₂O. The mixture was stirred overnight at room temperature. After 18 hours, the reaction mixture was green with white precipitate. The solution was filtered, and solid was collected and washed with additional ether and pentane. ¹H NMR (THF-d8) shows clean product (2.1 g, 40% yield).

To a cold solution of Me₄CpSiMe₂OTf (1.5 g, 4.75 mmol) was slowly added (5-isopropyl-3,8-dimethyl-4-phenyl-2,4-dihydroazulen-1-yl)lithium (1.29 g, 4.57 mmol) as a solid. The mixture was allowed to react overnight. After 18 hours, solvent was removed in vacuo and the residue was extracted with pentane and filtered over Celite. Solvent was removed again to afford a yellow oil, which appears of reasonable purity. Azulene was manifested as two major isomers with some minor impurities (2.1 g isolated, 100% yield). ¹H NMR (400 MHz, Benzene-d6) δ 7.39-7.24 (m, 2H), 7.23-7.01 (m, 3H), 6.47-5.86 (m, 2H), 4.84 (m, 1H), 3.42-2.82 (m, 1H), 2.79-2.48 (m, 1H), 2.33-1.64 (m, 18H), 1.28-1.15 (m, 6H), 0.32-−0.44 (m, 6H).

n-BuLi (3.6 mL, 2.7 M in hexane) was slowly added to a pre-cooled diethylether solution of ligand (2.1 g, 4.9 mmol). The mixture was then allowed to warm up and was stirred for 5 hours. After 5 hours, solvent was removed in vacuo and the residue was suspended in pentane and stirred for 30 minutes. The mixture was filtered to give a dark red powder, which appear reasonably clean by ¹H NMR and was used without further purification in the next step. The molecule was isolated as 0.35 equiv. ether adduct, as two isomers in essentially quantitative yield (2.3 g isolated, 100% yield). ¹H NMR (400 MHz, THF-d8) δ 7.00 (m, 5H), 6.13 (m, 1H), 5.76 (m, 1H), 5.19 (m, 1H), 4.72 (m, 1H), 2.58 (m, 1H), 2.33-2.28 (two s, 3H) 2.21-1.88 (overlapping singlets, 15H), 1.19-1.09 (m, 6H), 0.45 (overlapping m, 6H).

ZrCl₄(OEt₂)₂ (0.8 g, 2.1 mmol) was slurried in diethylether and cooled in the freezer to −35° C. While stirring, delithiated ligand solid (1.0 g, 2.1 mmol) was added in portion. The mixture was allowed to stir overnight at room temperature. After 18 hours, solvent was removed in vacuo and the residue was extracted with methylene chloride (2×20 mL) and filtered over Celite. Solvent was removed again in vacuo to give yellow residue. Addition of excess pentane precipitated yellow powder, which was collected and dried in vacuo to give a first crop of material (0.375 g). The supernatant solution was collected, concentrated to ca 10 mL and placed in a freezer. After 3 days, additional crop of material was obtained (0.490 g). Both crops are diastereomerically enriched and appear to have good purity (0.87 g isolated, 66% yield). ¹H NMR (400 MHz, Methylene Chloride-d2) δ 7.58 (m, 1H), 7.38 (m, 1H), 7.21 (m, 2H), 7.10 (s, 2H), 6.13 (d, 2H), 5.83 (two d, 2H), 4.75 (two s, 1H), 2.61 (m, 1H), 2.27-1.86 (overlapping s, 24H, Methyl peaks), 1.05 (m, 6H, iPr), 0.95-0.87 (4s, 6H, SiMe₂).

### Synthesis of Catalyst I4

Guaiazulene (1.05 g) was suspended in pentane (30 mL) and cooled in the freezer. Diethylether (ca 0.55 mL) was then added to the mixture. While cold, a solution of t-BuLi (3.1 mL of 1.7M) was slowly added to ink blue azulene solution. Upon completion the reaction mixture became brown and was stirred overnight. After 18 hours, solvent was removed in vacuo. The mixture was re-suspended in diethylether and cooled in the freezer. In a separate flask, 1.73 g of Me₄CpSiMe₂Otf was suspended in 20 mL of diethylether and cooled in the freezer. While cold, the solution of lithium azulene was slowly transferred to a cold solution of Me₄Cp. The reaction was allowed to stir for 2 hours. After 2 hours, the mixture was concentrated under vacuum. The residue was extracted with pentane (2×20 mL) and filtered through Celite. Solvent removal afforded the ligand as pale oil in essentially quantitative yield as multiple isomers with minor impurities. ¹H NMR (400 MHz, C6D6) 6.55-5.51 (multiple s, 3H, isomers, azulene olefinic and Cp) 3.52-2.58 (m, 2H) 2.28 (m, 1H, iPr) 2.10 (s, 3H) 2.02 (s, 3H) 1.92 (s, 3H) 1.83 (overlapping s, 6H) 1.23 (m, 3H) 1.11 (m, 6H, iPr) 1.00-0.91 (two s, tBu) 0.16-0.18 (overlapping s, 6H, SiMe₂).

n-BuLi (4.0 mL of 2.7 M) was slowly added to a pre-cooled mixture of ligand (2.3 g) in diethylether. The mixture was allowed to stir overnight. After 18 hours, solvent was removed in vacuo, and the residue was washed with pentane (2×20 mL) and dried in vacuo to give a reasonably pure dilithium ligand as beige solid. ¹H NMR (400 MHz, THF-d8) δ 6.49 (s, 1H), 5.93 (s, 1H), 4.91 (m, 1H), 2.44 (d, J=8.7 Hz, 1H), 2.18 (s, 3H), 2.07 (s, 3H), 2.01 (s, 3H), 1.94 (s, 6H), 1.18 (m, 6H), 1.00 (d, 3H), 0.79 (s, 9H, tBu), 0.43 (d, 6H SiMe₂).

To a precooled, stirring solution of lithium dimethyl(4-tert-butyl-5-isopropyl-3,8-dimethyl-2,4-dihydroazulenidyl)(2,3,4,5-tetramethylcyclopentadienyl)silane (1.772 g, 3.97 mmol) in diethyl ether (50 mL), zirconium chloride (0.925 g, 3.97 mmol, 1 equiv.) and toluene (2 mL) were added. The reaction was stirred at room temperature for 14 hours. The reaction was concentrated under a stream of nitrogen and then under high vacuum. The residue was extracted with dichloromethane (2×20 mL) and filtered over Celite. The combined dichloromethane extracts were concentrated under a stream of nitrogen and then under high vacuum. The residue was stirred in pentane (20 mL). The resulting suspension was filtered. The filtered solid was collected and concentrated under high vacuum. The solid was dissolved in pentane (20 mL) and cooled to −35° C. The resulting precipitate was collected and concentrated under high vacuum to give a yellow-brown solid. Pentane (10 mL) was added to the solid, and the solid was scraped into the mixture to form a suspension. The suspension was filtered, and the filtered solid was collected and concentrated under high vacuum to afford the product as a yellow solid (0.562 g, 24% yield, 1:1.8 mixture of isomers). ¹H NMR (400 MHz, CD₂Cl₂): δ 6.59 (br s, 1H, isomer 1), 6.47 (s, 1H, isomer 2), 5.76 (br s, 1H, isomer 1), 5.67 (br d, 1H, J=6.7 Hz, isomer 1), 5.62 (dd, 1H, J=8.8, 1.4 Hz, isomer 2), 5.52 (s, 1H, isomer 2), 2.85 (br s, 1H, isomer 1), 2.67 (dd, 1H, J=8.7, 1.2 Hz, isomer 2), 2.27-2.16 (m, 2H, isomers 1 and 2), 2.13 (br s, 3H, isomer 1), 2.12 (s, 3H, isomer 1), 2.06 (s, 3H, isomer 2), 2.03 (s, 6H, isomers 1 and 2), 2.02 (s, 3H, isomer 2), 2.01 (s, 3H, isomer 1), 1.98 (s, 3H, isomers 1 and 2), 1.96 (s, 3H, isomer 2), 1.88 (t, 3H, J=1.2 Hz, isomer 1), 1.83 (d, 1.3 Hz, isomer 2), 1.23-1.17 (m, 6H, isomers 1 and 2), 1.04 (s, 9H, isomer 1), 0.99 (d, 3H, J=6.7 Hz, isomer 2), 0.93-0.89 (m, 12H, isomers 1 and 2), 0.88 (s, 3H, isomer 2), 0.71 (s, 9H, isomer 2).

### Synthesis of Catalyst I5

A stirring mixture of dimethylsilyl (3,4,8-trimethyl-5-isopropyl-2,4-dihydroazulenyl) (2,3,4,5-tetramethylcyclopentadienyl) zirconium dichloride (0.240 g, 0.434 mmol) and platinum (IV) oxide (0.015 g, 66 μmol, 15 mol %) in dichloromethane (10 mL) in a pressure vessel was pressurized with hydrogen gas to 50 psi. The reaction was stirred at room temperature for 27 hours. The reaction was filtered through Celite on glass wool. The filtrate was concentrated under a stream of nitrogen and then under high vacuum. The residue was extracted with pentane and filtered over Celite. The filtrate was concentrated under a stream of nitrogen and then under high vacuum to afford the product as a yellow foam (0.199 g, 82% yield, mixture of eight isomers). ¹H NMR (400 MHz, C6D6): δ 5.53-5.22 (m, 8H), 3.41-2.73 (m, 8H), 2.27-1.60 (m, 136H), 1.59-0.65 (m, 144H), 0.63-0.17 (m, 48H).

### Synthesis of Catalyst I6

A mixture of dimethylsilyl (4-tert-butyl-5-isopropyl-3,8-dimethyl-2,4-dihydroazulenyl) (2,3,4,5-tetramethylcyclopentadienyl) zirconium dichloride (0.404 g, 679 micromoles (μmol)) and platinum (IV) oxide (0.030 g, 132 μmol, 0.19 equiv.) in dichloromethane (100 mL) was pressurized in a Parr reactor. The contents of the reactor were stirred, pressurized with hydrogen gas to 500 psi, and heated to 80° C. for 22 hours. Then, additional platinum (IV) oxide (0.020 g, 88 μmol, 0.13 equiv.) was added, and the contents of the reactor were pressurized with hydrogen gas to 1000 psi and then heated to 120° C. for 19 hours. The reactor was allowed to cool to room temperature and depressurize. The reaction was filtered over Celite. The filtrate was concentrated under a stream of nitrogen and then under high vacuum. The residue was stirred in pentane (20 mL) overnight. The resulting mixture was filtered over Celite. The filtrate was concentrated under a stream of nitrogen and then under high vacuum to afford the product as a brown oil (0.157 g, 39% yield). ¹H NMR (400 MHz, CD₂Cl₂): δ6.15-5.55 (m, 8H), 2.71-0.01 (m, 376H).

### Synthesis of Catalyst I7

To a stirring solution of guaiazulene (1.00 g, 5.04 mmol) in diethyl ether (20 mL), a solution of lithium aluminum hydride (4.8 mL, 1.04 M in diethyl ether, 5.0 mmol, 0.99 equiv.) was added. The reaction was stirred and heated to reflux for 41 hours. The reaction was filtered over Celite. The filtered solid was washed with additional diethyl ether (50 mL). The filtrate was discarded. The filtered solid was then extracted through the Celite with tetrahydrofuran (3×20 mL). The tetrahydrofuran extract was concentrated under a stream of nitrogen and then under high vacuum to give an off-white solid. The residue was washed further with diethyl ether (20 mL) and filtered on a plastic, fritted funnel. The filtered solid was collected and concentrated under high vacuum to afford the product as a white solid (0.593 g, 57% yield). ¹H NMR (400 MHz, C₄D₈O): δ 5.65 (d, 1H, J=3.4 Hz), 5.61 (d, 1H, J=3.4 Hz), 5.47 (dt, 1H, J=6.2, 1.0 Hz), 5.35 (dq, 1H, J=6.3, 1.3 Hz), 2.88 (s, 2H), 2.42 (hept, 1H, J=6.7 Hz), 2.10 (s, 3H), 2.09 (s, 3H), 1.08 (d, 6H, J=6.8 Hz).

To a stirring suspension of zirconium chloride diethyl etherate (0.200 g, 0.525 mmol) in diethyl ether (5 mL), a suspension of lithium 5-isopropyl-3,8-dimethyl-2,4-dihydroazulenide (0.218 g, 1.06 mmol, 2.01 equiv.) in diethyl ether (15 mL) was added. The reaction was stirred at room temperature for 5 hours. The reaction was concentrated under a stream of nitrogen and then under high vacuum. The residue was extracted with dichloromethane (20 mL, then 2×10 mL) and filtered over Celite. The combined dichloromethane extracts were concentrated under a stream of nitrogen and then under high vacuum to afford the product as a pale green solid (0.297 g, 100% yield, 1:1 mixture of isomers). ¹H NMR (400 MHz, CD₂Cl₂): δ 6.25 (d, 2H, J=3.0 Hz), 6.19 (d, 2H, J=3.0 Hz), 6.08-6.03 (m, 6H), 6.01 (dd, 2H, J=6.6, 1.5 Hz), 5.69 (d, 2H, J=6.9 Hz), 5.67 (d, 2H, J=5.8 Hz), 3.24 (dd, 2H, J=14.6, 1.5 Hz), 3.21-3.19 (m, 2H), 3.06 (dd, 2H, J=14.3, 2.0 Hz), 2.44 (hept, 4H, J=7.0 Hz), 2.15 (s, 6H), 2.13 (s, 6H), 2.01 (s, 6H), 1.91 (s, 6H), 1.09-1.04 (m, 24H).

### Synthesis of Catalyst I8

To a stirring suspension of zirconium chloride diethyl etherate (0.510 g, 1.34 mmol) in diethyl ether (5 mL), a suspension of lithium 5-isopropyl-3,5-dimethyl-4-phenyl-1,4-dihydroazulenide (0.758 g, 2.68 mmol, 2.01 equiv.) in diethyl ether (15 mL) was added. The reaction was stirred at room temperature for 16 hours. The reaction was concentrated under a stream of nitrogen and then under high vacuum. The residue was extracted with dichloromethane (20 mL, then 10 mL) and filtered over Celite. The combined dichloromethane extracts were concentrated under a stream of nitrogen and then under high vacuum to afford the product as a pale green solid (0.853 g, 89% yield, mixture of six isomers). ¹H NMR (400 MHz, CD₂Cl₂): δ 7.50-6.94 (m, 60H), 6.30-5.53 (m, 48H), 5.27-4.49 (m, 12H), 3.25-1.77 (m, 82H), 1.40-0.63 (m, 74H).

### Polymerization Procedure

A pre-weighed glass vial insert and disposable stirring paddle were fitted to each reaction vessel of the reactor, which contains 48 individual reaction vessels. The reactor was then closed and ethylene gas was introduced at a desired pressure. Then, solvent (typically isohexane) was added to bring the total reaction volume, including the subsequent additions, to 5 mL, and the reactor vessels were heated to their set temperature (usually from 50° C. to 110° C.). The contents of the vessel were stirred at 800 revolutions per minute (rpm). An activator solution (typically 100-1000 molar equivalents of methyl alumoxane (MAO) in toluene) was then injected into the reaction vessel along with 500 microliters of toluene, followed by addition of 1-octene (typically 20-160 microliters μL)). Catalyst (typically 0.50 millimolar (mM) in toluene, such as 15-40 nanomoles (nmol) of catalyst) and another aliquot of toluene (500 μL) were then added to initiate the reaction. Equivalence is determined based on the molar equivalents relative to the moles of the transition metal in the catalyst complex. The reaction was then allowed to proceed until a pre-determined amount of pressure had been taken up by the reaction. Alternatively, the reaction may be allowed to proceed for a set amount of time. Subsequently, the reaction was quenched by pressurizing the vessel with compressed air. After the polymerization reaction, the glass vial insert containing the polymer product and solvent was removed from the pressure cell and the inert atmosphere glove box, and the volatile components were removed using a Genevac HT-12 centrifuge and Genevac VC3000D vacuum evaporator operating at elevated temperature and reduced pressure. The vial was then weighed to determine the yield of the polymer product. The resultant polymer was analyzed by Rapid Gel Permeation Chromatography (GPC) to determine the molecular weight and by Differential Scanning Calorimetry (DSC) to determine melting point.

### Rapid Gel Permeation Chromatography (GPC) Procedure

To determine various molecular weight related values by GPC, high temperature size 5 exclusion chromatography was performed using an automated “Rapid GPC” system as generally described in U.S. Pat. Nos. 6,491,816; 6,491,823; 6,475,391; 6,461,515; 6,436,292; 6,406,632; 6,175,409; 6,454,947; 6,260,407; and 6,294,388, each of which is fully incorporated herein by reference for all purposes. This apparatus has a series of three 30 cm×7.5 mm linear columns, each containing PLgel 10 μm, Mix B. The GPC system was calibrated using polystyrene standards ranging from 580-3,390,000 g/mol. The system was operated at an eluent flow rate of 2.0 mL/minute and an oven temperature of 165° C. 1,2,4-trichlorobenzene was used as the eluent. The polymer samples were dissolved in 1,2,4-trichlorobenzene at a concentration of 0.1-0.9 milligrams per milliliter (mg/mL). 250 μL of a polymer solution was injected into the system. The concentration of the polymer in the eluent was monitored using an evaporative light scattering detector (as shown by the examples in Table 3) or Polymer Char IR4 detector. The molecular weights presented are relative to linear polystyrene standards and are uncorrected.

### Differential Scanning Calorimetry (DSC) Procedure

For the high throughput samples, the melting temperature (Tm) was measured using Differential Scanning Calorimetry (DSC) using commercially available equipment, such as a TA Instruments TA-Q200 DSC. Typically, 5 to 10 mg of molded polymer or plasticized polymer is sealed in an aluminum pan and loaded into the instrument at room temperature. Samples were pre-annealed at 220° C. for 15 minutes and then allowed to cool to room temperature overnight. The samples were then heated to 220° C. at a heating rate of 100° C. per minute, held at this temperature for at least 5 minutes, and then cooled at a rate of 50° C. per minute to a temperature typically at least 50° C. below the crystallization temperature. Melting points were collected during the heating period.

### Example Experimental Results

Table 1 includes entries that each indicates the conditions and results of an example experiment in which a comparative catalyst (i.e., C₁-C₉) or an embodiment of an inventive catalyst (i.e., I1-I8) was used in either an ethylene polymerization or an ethylene-octene copolymerization, in accordance with the example polymerization procedure discussed above. For the examples indicated in Table 1, the polymerization conditions include: 20 nanomoles (nmol) of the indicated catalyst, 500 equivalents of MAO, isohexane as the solvent or diluent, and 120 psi of ethylene.

TABLE 1
Example polymerization conditions and results.

| | | 1-octene | Activity | Mn | Mw | Tm | 1-octene |
|---|---|---|---|---|---|---|---|
| Example | Catalyst | (μL) | (kg/mmol · h) | (g/mol) | (g/mol) | (° C.) | (wt %) |
| 1 | C1 | 0 | 442.0 | 84,406 | 165,487 | 136.0 | 0.0 |
| 2 | C1 | 0 | 408.5 | 98,195 | 182,576 | 136.3 | 0.0 |
| 3 | C1 | 100 | 518.5 | 81,863 | 162,546 | 126.1 | 2.1 |
| 4 | C1 | 100 | 216.4 | 68,350 | 148,626 | 127.1 | 2.6 |
| 5 | C1 | 200 | 441.0 | 79,924 | 168,112 | 125.4 | 2.9 |
| 6 | C1 | 200 | 426.3 | 89,776 | 194,633 | 124.2 | 3.9 |
| 7 | C2 | 0 | 431.0 | 75,756 | 187,276 | 136.0 | 0.0 |
| 8 | C2 | 0 | 427.9 | 82,786 | 193,057 | 135.8 | 0.0 |
| 9 | C2 | 100 | 462.2 | 89,247 | 184,378 | 130.8 | 1.0 |
| 10 | C2 | 100 | 501.1 | 86,116 | 184,792 | 130.6 | 1.0 |
| 11 | C2 | 200 | 480.2 | 76,321 | 173,503 | 127.1 | 2.0 |
| 12 | C2 | 200 | 470.1 | 77,809 | 185,304 | 127.1 | 2.7 |
| 13 | C2 | 100 | 459.3 | 94,122 | 176,593 | 132.9 | 1.0 |
| 14 | C2 | 100 | 447.8 | 95,720 | 174,090 | 132.4 | 0.7 |
| 15 | C2 | 100 | 429.9 | 78,400 | 177,845 | 132.1 | 1.0 |
| 16 | C2 | 200 | 275.3 | 100,086 | 184,333 | 130.0 | 3.0 |
| 17 | C2 | 200 | 402.3 | 89,743 | 174,933 | 129.7 | 3.3 |
| 18 | C2 | 200 | 418.0 | 86,452 | 166,117 | 129.3 | 4.3 |
| 19 | C3 | 0 | 398.8 | 92,047 | 184,729 | 135.5 | 0.0 |
| 20 | C3 | 0 | 351.6 | 81,102 | 180,417 | 135.6 | 0.0 |
| 21 | C3 | 100 | 448.4 | 91,789 | 190,884 | 128.2 | 2.0 |
| 22 | C3 | 100 | 421.5 | 80,223 | 202,050 | 128.1 | 2.8 |
| 23 | C3 | 200 | 378.4 | 70,366 | 186,849 | 124.9 | 4.1 |
| 24 | C3 | 200 | 409.1 | 74,921 | 191,510 | 125.5 | 3.9 |
| 25 | C4 | 0 | 240.4 | 82,981 | 177,449 | 135.5 | 0.0 |
| 26 | C4 | 0 | 368.0 | 76,727 | 172,529 | 136.0 | 0.0 |
| 27 | C4 | 100 | 354.4 | 81,753 | 161,719 | 120.7 | 3.8 |
| 28 | C4 | 100 | 310.3 | 89,844 | 173,069 | 120.7 | 3.2 |
| 29 | C4 | 200 | 272.5 | 78,030 | 160,079 | 113.8 | 6.7 |
| 30 | C4 | 200 | 300.1 | 65,800 | 143,004 | 113.3 | 4.2 |
| 31 | C5 | 0 | 375.1 | 143,289 | 283,871 | 136.1 | 0.0 |
| 32 | C5 | 0 | 274.1 | 123,038 | 284,119 | 136.7 | 0.0 |
| 33 | C5 | 100 | 267.9 | 113,495 | 257,607 | 125.1 | 1.7 |
| 34 | C5 | 100 | 313.6 | 142,624 | 289,552 | 125.4 | 2.1 |
| 35 | C5 | 200 | 282.5 | 126,862 | 261,013 | 120.4 | 3.2 |
| 36 | C5 | 200 | 295.2 | 131,378 | 256,131 | 119.8 | 4.7 |
| 37 | C6 | 0 | 537.8 | 121,490 | 325,853 | 136.6 | 0.0 |
| 38 | C6 | 0 | 424.1 | 108,707 | 342,835 | 136.2 | 0.0 |
| 39 | C6 | 100 | 398.8 | 90,491 | 298,973 | 128.7 | 1.5 |
| 40 | C6 | 100 | 505.0 | 97,899 | 281,677 | 128.7 | 1.8 |
| 41 | C6 | 200 | 445.1 | 68,125 | 250,156 | 125.6 | 1.9 |
| 42 | C6 | 200 | 686.8 | 66,474 | 232,217 | 125.5 | 2.9 |
| 43 | C6 | 100 | 451.4 | 103,982 | 263,172 | 131.1 | 1.7 |
| 44 | C6 | 100 | 531.3 | 106,297 | 286,337 | 132.0 | 1.9 |
| 45 | C6 | 100 | 434.3 | 110,465 | 302,210 | 130.4 | 2.8 |
| 46 | C6 | 200 | 444.3 | 120,276 | 267,386 | 128.6 | 3.2 |
| 47 | C6 | 200 | 524.7 | 98,962 | 296,662 | 128.8 | 3.6 |
| 48 | C6 | 200 | 507.9 | 120,006 | 292,633 | 128.0 | 4.3 |
| 49 | C7 | 0 | 524.4 | 62,832 | 126,010 | 134.4 | 0.0 |
| 50 | C7 | 0 | 524.4 | 58,188 | 125,436 | 134.2 | 0.0 |
| 51 | C7 | 100 | 484.1 | 65,156 | 118,406 | 112.1 | 7.6 |
| 52 | C7 | 100 | 552.7 | 55,942 | 111,941 | 112.0 | 8.4 |
| 53 | C7 | 200 | 453.7 | 61,831 | 113,216 | 98.1 | 11.3 |
| 54 | C7 | 200 | 574.0 | 55,734 | 113,034 | 103.3 | 11.6 |
| 55 | C8 | 0 | 378.0 | 177,246 | 362,999 | 136.7 | 0.0 |
| 56 | C8 | 0 | 411.4 | 180,121 | 367,127 | 138.3 | 0.0 |
| 57 | C8 | 100 | 291.9 | 110,179 | 292,907 | 127.8 | 1.1 |
| 58 | C8 | 100 | 298.0 | 110,563 | 327,916 | 127.3 | 2.5 |
| 59 | C8 | 200 | 277.1 | 120,124 | 259,570 | 124.5 | 2.7 |
| 60 | C8 | 200 | 205.0 | 113,254 | 283,072 | 124.0 | 2.9 |
| 61 | C8 | 100 | 378.0 | 134,099 | 276,248 | 129.0 | 1.7 |
| 62 | C8 | 100 | 411.4 | 133,713 | 268,117 | 129.2 | 2.2 |
| 63 | C8 | 100 | 291.9 | 135,110 | 278,211 | 129.3 | 1.9 |
| 64 | C8 | 200 | 298.0 | 111,294 | 253,789 | 126.4 | 3.1 |
| 65 | C8 | 200 | 277.1 | 131,640 | 262,063 | 125.9 | 4.2 |
| 66 | C8 | 200 | 205.0 | 133,476 | 281,751 | 127.3 | 3.2 |
| 67 | C9 | 100 | 602.1 | 131,147 | 239,963 | 132.1 | 1.5 |
| 68 | C9 | 100 | 633.7 | 125,777 | 249,803 | 132.1 | 1.4 |
| 69 | C9 | 100 | 513.6 | 113,416 | 237,035 | 132.4 | 1.2 |
| 70 | C9 | 200 | 522.0 | 117,324 | 226,330 | 129.5 | 2.0 |
| 71 | C9 | 200 | 487.5 | 105,839 | 221,992 | 129.1 | 2.2 |
| 72 | C9 | 200 | 507.2 | 126,787 | 250,061 | 128.9 | 2.3 |
| 73 | I1 | 0 | 196.6 | 251,593 | 688,090 | 136.2 | 0.0 |
| 74 | I1 | 0 | 209.9 | 200,106 | 532,681 | 136.1 | 0.0 |
| 75 | I1 | 100 | 307.6 | 125,136 | 400,487 | 122.2 | 3.1 |
| 76 | I1 | 100 | 322.7 | 142,636 | 391,379 | 122.9 | 3.0 |
| 77 | I1 | 200 | 289.2 | 109,652 | 326,554 | 117.4 | 4.9 |
| 78 | I1 | 200 | 272.4 | 98,951 | 316,852 | 117.8 | 4.7 |
| 79 | I2 | 0 | 268.5 | 207,336 | 535,533 | 136.9 | 0.0 |
| 80 | I2 | 0 | 262.9 | 205,773 | 515,260 | 136.6 | 0.0 |
| 81 | I2 | 100 | 299.9 | 164,852 | 462,559 | 131.0 | 1.3 |
| 82 | I2 | 100 | 294.6 | 219,506 | 615,894 | 130.5 | 1.2 |
| 83 | I2 | 200 | 291.9 | 184,693 | 517,001 | 128.4 | 1.8 |
| 84 | I2 | 200 | 279.2 | 225,960 | 531,672 | 128.3 | 2.3 |
| 85 | I2 | 100 | 285.2 | 196,658 | 500,163 | 132.7 | 1.4 |
| 86 | I2 | 100 | 242.0 | 227,268 | 456,466 | 133.0 | 1.6 |
| 87 | I2 | 100 | 252.8 | 163,246 | 412,312 | 132.0 | 1.5 |
| 88 | I2 | 200 | 234.0 | 179,910 | 409,647 | 129.9 | 2.4 |
| 89 | I2 | 200 | 202.8 | 165,287 | 422,658 | 129.5 | 2.4 |
| 90 | I3 | 0 | 76.5 | 251,684 | 713,615 | 136.0 | 0.0 |
| 91 | I3 | 0 | 78.6 | 264,981 | 721,748 | 136.3 | 0.0 |
| 92 | I3 | 100 | 63.4 | 241,225 | 783,318 | 129.0 | 1.3 |
| 93 | I3 | 200 | 50.6 | 287,017 | 764,600 | 125.9 | 2.4 |
| 94 | I3 | 200 | 53.1 | 265,895 | 749,900 | 126.5 | 3.2 |
| 95 | I3 | 0 | 89.3 | 213,284 | 567,683 | 136.4 | 0.0 |
| 96 | I3 | 0 | 94.1 | 190,981 | 567,645 | 136.6 | 0.0 |
| 97 | I3 | 100 | 57.7 | 227,318 | 684,574 | 129.0 | 1.3 |
| 98 | I3 | 100 | 69.0 | 229,275 | 683,605 | 129.1 | 1.4 |
| 99 | I3 | 200 | 48.5 | 225,352 | 706,234 | 125.7 | 2.0 |
| 100 | I3 | 200 | 52.3 | 220,029 | 769,600 | 125.4 | 2.0 |
| 101 | I4 | 100 | 84.1 | 124,421 | 263,015 | 118.2 | 4.8 |
| 102 | I4 | 100 | 90.4 | 129,107 | 270,705 | 120.0 | 5.8 |
| 103 | I4 | 100 | 72.7 | 127,372 | 268,772 | 120.7 | 4.5 |
| 104 | I4 | 200 | 70.3 | 80,023 | 187,687 | 109.6 | 10.5 |
| 105 | I4 | 200 | 68.2 | 91,613 | 186,099 | 120.9 | 12.0 |
| 106 | I4 | 200 | 69.1 | 73,822 | 172,307 | 120.9 | 10.1 |
| 107 | I5 | 0 | 256.0 | 152,752 | 522,471 | 136.4 | 0.0 |
| 108 | I5 | 0 | 269.3 | 176,043 | 513,773 | 137.5 | 0.0 |
| 109 | I5 | 100 | 200.8 | 141,223 | 465,035 | 132.6 | 1.4 |
| 110 | I5 | 200 | 205.8 | 125,027 | 431,492 | 130.5 | 2.0 |
| 111 | I5 | 200 | 205.8 | 126,343 | 436,263 | 130.7 | 1.8 |
| 112 | I5 | 100 | 226.8 | 154,607 | 452,140 | 135.1 | 0.9 |
| 113 | I5 | 100 | 269.4 | 184,379 | 480,226 | 134.2 | 1.0 |
| 114 | I5 | 100 | 248.5 | 187,009 | 479,075 | 134.3 | 0.9 |
| 115 | I5 | 200 | 243.1 | 158,246 | 451,858 | 132.2 | 1.1 |
| 116 | I5 | 200 | 230.8 | 180,737 | 498,805 | 132.4 | 1.9 |
| 117 | I5 | 200 | 227.8 | 167,947 | 441,464 | 133.0 | 1.9 |
| 118 | I6 | 100 | 57.5 | 137,242 | 273,356 | 129.0 | 3.7 |
| 119 | I6 | 100 | 56.3 | 129,702 | 271,564 | 128.3 | 3.0 |
| 120 | I6 | 100 | 53.1 | 140,907 | 284,015 | 129.2 | 2.4 |
| 121 | I6 | 200 | 68.0 | 105,767 | 210,814 | 124.4 | 4.9 |
| 122 | I6 | 200 | 68.8 | 104,625 | 200,023 | 124.4 | 4.5 |
| 123 | I7 | 0 | 37.2 | 282,518 | 689,299 | 136.5 | 0.0 |
| 124 | I7 | 0 | 45.8 | 269,622 | 755,065 | 137.6 | 0.0 |
| 125 | I7 | 100 | 23.4 | 209,141 | 392,768 | 122.0 | 1.6 |
| 126 | I7 | 100 | 25.8 | 194,851 | 410,216 | 122.3 | 3.2 |
| 127 | I7 | 200 | 16.4 | 87,382 | 353,982 | 116.6 | 6.9 |
| 128 | I7 | 200 | 17.1 | 171,522 | 336,104 | 116.2 | 6.9 |
| 129 | I8 | 0 | 4.3 | 366,748 | 1,283,187 | 136.8 | 0.0 |
| 130 | I8 | 0 | 3.3 | 308,654 | 1,235,756 | 137.7 | 0.0 |
| 131 | I8 | 100 | 2.0 | 276,950 | 960,592 | 128.9 | 0.5 |
| 132 | I8 | 100 | 2.3 | 224,633 | 967,460 | 128.6 | 2.8 |
| 133 | I8 | 200 | 2.3 | 179,001 | 731,112 | 125.4 | 5.3 |
| 134 | I8 | 200 | 2.1 | 171,555 | 642,263 | 125.8 | 5.9 |

The results presented in Table 1 highlight the versatility of the presently described guaiazulene-based catalysts, particularly embodiments I1-I6. These embodiments demonstrate significant improvement in molecular weight capability at the fraction of activity loss relative to the comparative catalysts. Due at least in part to relative ease of synthesis of these catalysts, as well as the low cost of guaiazulene starting materials, the embodiments of the guaiazulene-based catalysts disclosed herein enable reduced costs for olefin production, as compared to conventional azulene-based catalysts (e.g., comparative catalysts C₁-C₉).

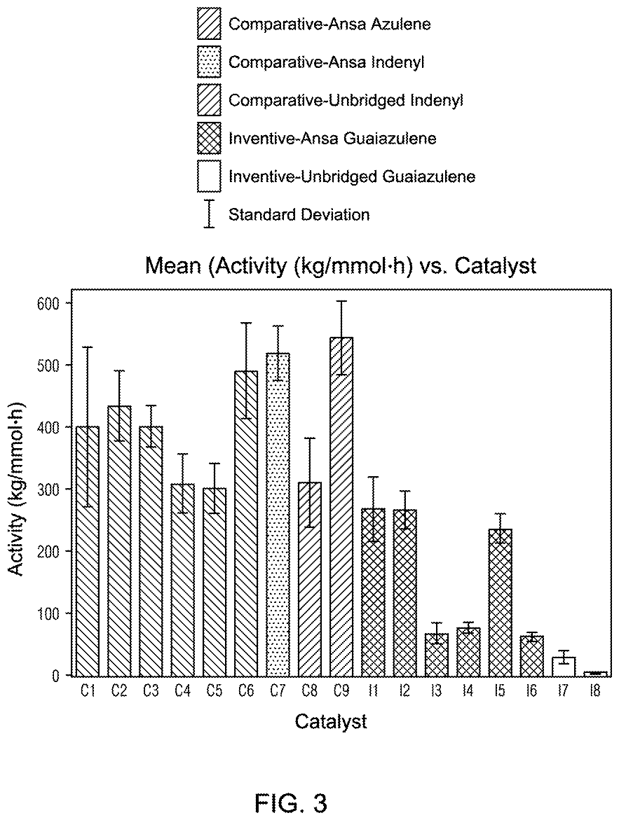

FIGS. 3-6 are different graphs that visualize the example experimental results of Table 1. In particular, FIG. 3 is a bar graph that indicates the average activity in kilograms per millimole hours (kg/mmol-h) for each of the comparative catalysts (i.e., C₁-C₉) and each of the embodiments of the inventive catalysts (i.e., I1-I8) included in Table 1. The bar graph of FIG. 3 indicates that the average activities of certain embodiments of the inventive catalysts (e.g., I1-16) are on the same order of magnitude (10² kg/mmol·h) and comparable to some azulene derivatives and unbridged metallocenes (e.g., C₁-C₉).

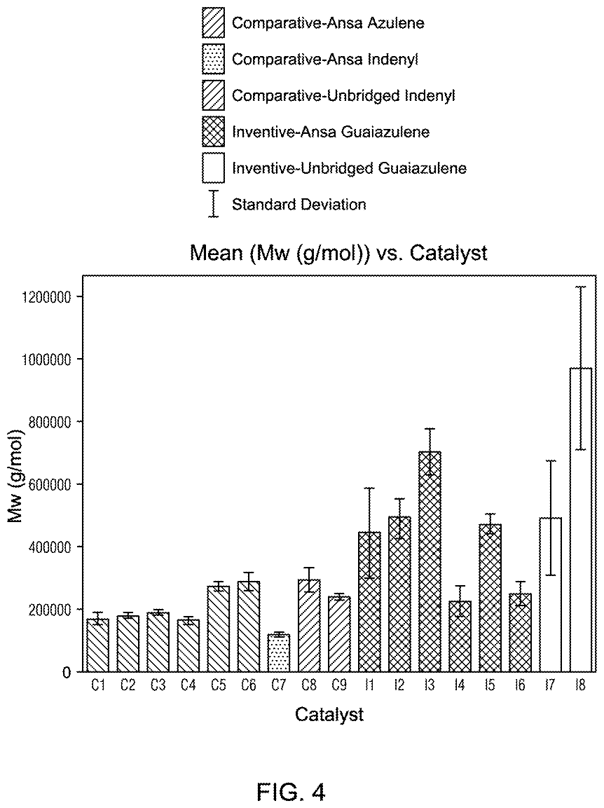

FIG. 4 is a bar graph illustrating the mean molecular weight (Mw) in grams per mole (g/mol) for the polymer product produced by each of the comparative catalysts (i.e., C₁-C₉) and each of the embodiments of the inventive catalysts (i.e., I1-I8), as indicated in Table 1. As indicated by the bar graph of FIG. 4, embodiments of the inventive catalysts (e.g., I1-I8) demonstrate significant improvement of Mw capability relative to all of the comparative catalysts (e.g., C₁-C₉). For certain embodiments, it is presently recognized that a higher molecular weight capability is desirable as it expands process operability, especially at higher polymerization temperatures.

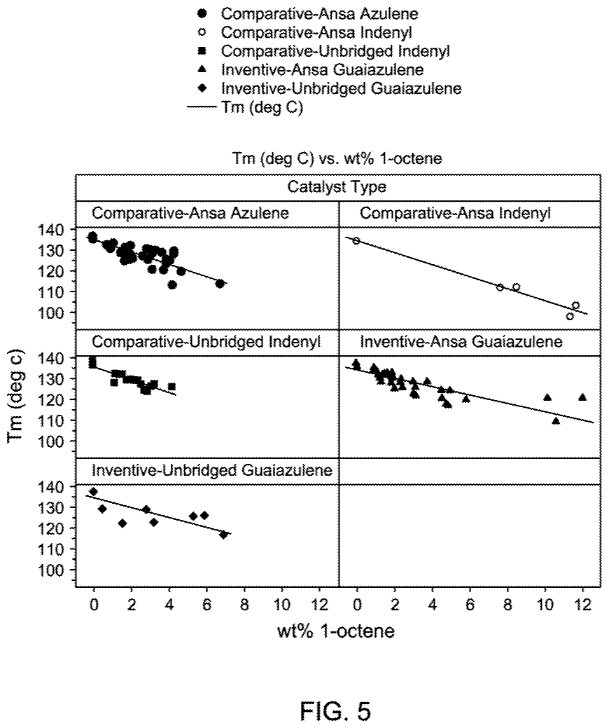

FIG. 5 is a set of graphs plotting melting temperature (Tm) versus weight percent of 1-octene comonomer for the polymer product produced by each of the comparative catalysts (i.e., C₁-C₉) and each of the embodiments of the inventive catalysts (i.e., I1-I8), as indicated in Table 1. For these graphs, the inventive guaiazulene-based catalysts and the comparative catalysts are grouped by type, including comparative ansa azulene catalysts (C₁-C₆), comparative ansa indenyl catalysts (C₇), comparative unbridged indenyl catalysts (C₈, C₉), inventive ansa guaiazulene catalysts (I1-I6), and inventive unbridged guaiazulene catalysts (I7, I8). As such, the set of graphs illustrate composition space up to 10 wt % 1-octene in the EO copolymer for each of these guaiazulene-based and comparative catalyst types. The graphs of FIG. 5 indicate that 1-octene incorporation is strongly influenced by substitution in the 4-position of the azulene moiety.

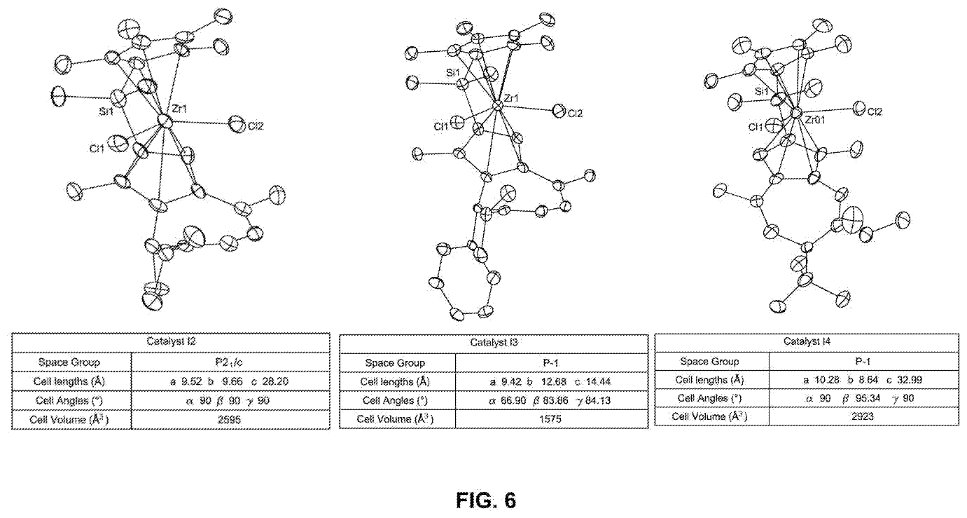

FIG. 6 is a graph that plots melting temperature (Tm) as a function of 1-octene content in microliters (μL) for the polymer products of a comparative ansa indenyl catalyst (C₇), a comparative unbridged indenyl catalyst (C8), and two embodiments of inventive ansa guaiazulene catalyst (I2, I5), as indicated in Table 1. As indicated by the graph, the inventive guaiazulene-based catalysts I2 and I5 demonstrate significantly less or poorer 1-octene incorporation than is observed for comparative catalyst C₇, and less 1-octene incorporation than is observed for comparative catalyst C₈, as the amount of 1-octene added increases. It is presently recognized that metallocene catalysts demonstrating poorer comonomer incorporation are highly desirable for gas phase polyethylene polymerization processes involving dual catalyst systems. Additionally, given their strong activation efficiency with MAO, it is believed that the guaiazulene-based catalysts disclosed herein are also compatible with solid MAO-type supports used in certain gas phase polyethylene polymerization processes.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims. Many alterations, modifications, and variations will be apparent to those skilled in the art in light of the foregoing description without departing from the spirit or scope of the present disclosure and that when numerical lower limits and numerical upper limits are listed herein, ranges from any lower limit to any upper limit are contemplated.

1. A catalyst compound represented by the formula: 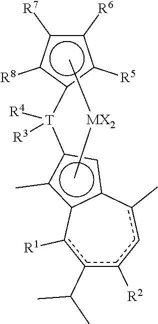
wherein:
M is a transition metal atom selected from group 4 of the Periodic Table of Elements;
each X is a univalent anionic ligand, or two Xs are joined and bound to the transition metal atom to form a metallocycle ring, or two Xs are joined to form a chelating ligand, a diene ligand, or an alkylidene ligand;
T is an optional bridging group that includes R³ and R⁴, wherein R³ and R⁴ are each independently a substituted or unsubstituted C₁ to C₂₀ hydrocarbyl group and can be joined to form a cyclic structure;
R⁵, R⁶, R⁷ and R⁸ are each independently a hydrogen atom or a substituted or unsubstituted C₁ to C₂₀ hydrocarbyl group and any two of R⁵, R⁶, R⁷, and R⁸ adjacent to each other can be joined to form a cyclic structure;
R¹ and R² are independently a hydrogen atom or a substituted or unsubstituted C₁ to C₂₀ hydrocarbyl group; and
the dashed bonds indicate optional double bonds.

2. The catalyst compound of claim 1, wherein R¹ and R² are a hydrogen atom, a methyl, ethyl, isopropyl, n-propyl, n-butyl, isobutyl, tertbutyl, n-pentyl, neopentyl, isopentyl, n-hexyl, isohexyl group, or a substituted or unsubstituted phenyl, napthyl or anthracenyl group.

3. The catalyst compound of claim 1, wherein the optional bridging group T is present and the catalyst compound is a bridged catalyst compound.

4. The catalyst compound of claim 3, wherein each of R⁵, R⁶, R⁷ and R⁸ is independently a methyl group and the catalyst compound is a bridged, ansa guaiazulene catalyst compound.

5. The catalyst compound of claim 4, wherein the optional double bonds are not present.

6. The catalyst compound of claim 1, wherein R⁵ and R⁸ is a hydrogen or a methyl group and R⁶ and R⁷ are joined to form a 7-member ring, and the catalyst compound is a bis-guaiazulene catalyst compound.

7. The catalyst compound of claim 6, wherein the optional bridging group T is not present and the catalyst compound is an unbridged, bis-guaiazulene catalyst compound.

8. The catalyst compound of claim 7, wherein the optional double bonds are not present.

9. A catalyst system comprising the catalyst compound of claim 1 and an activator.

10. The catalyst system of claim 9, wherein the activator is either aluminoxane or salts of non-coordinating (NCA) anions.

11. The catalyst system of claim 10, wherein the NCA activator is represented by the formula: 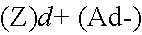
wherein:
Z is (L-H)+ or a reducible Lewis Acid;
L is a Lewis base;
H is hydrogen;
(L-H)+ is a Bronsted acid;
Ad- is a non-coordinating anion having charge d-; and
d is an integer from 1 to 3.

12. The catalyst system of claim 10, wherein the NCA activator is represented by the formula: 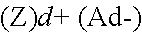
wherein:
Ad- is a non-coordinating anion having charge d-;
d is an integer from 1 to 3; and
Z is a reducible Lewis acid represented by the formula: 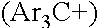
wherein Ar is aryl or aryl substituted with a heteroatom, a C₁ to C₄₀ hydrocarbyl, or a substituted C₁ to C₄₀ hydrocarbyl.

13. The catalyst system of claim 9, wherein a molar ratio of aluminum of the aluminoxane activator to the transition metal of the catalyst compound in the catalyst system is greater than 1:100, greater than 1:250, or greater than 1:500.

14. The catalyst system of claim 9, further comprising a support material, wherein the support material comprises alumina (Al₂O₃), zirconia (ZrO₂), silica (SiO₂), SiO₂/Al₂O₃, SiO₂/titania (TiO₂), silica clay, silicon oxide/clay, or mixtures thereof.

15. A process to prepare an olefin homopolymer or copolymer by:
introducing ethylene or propylene and optionally one or more C₄ to C₄₀ olefin comonomers, and a catalyst system of claim 9, and optionally hydrogen into a reactor at a reactor pressure from 0.07 megapascal (MPa) to 7 MPa and a reactor temperature from 20° C. to 150° C.; and
obtaining the olefin homopolymer or copolymer.

16. The process of claim 15 wherein the C₄ to C₄₀ comonomers consists of 1-butene, 1-pentene, 1-hexene, 2-methyl-1-pentene, vinylcyclobutane, 1-heptene, 1-octene, 1-decene, 1,5-hexadiene, 1,7-octadiene, and 1,9-decadiene.

17. The process of claim 15, wherein the olefin homopolymer or copolymer has a mean molecular weight (Mw) from 1,000 grams per mole (g/mol) to 1,000,000 g/mol, from 5,000 g/mol to 500,000 g/mol, or from 10,000 g/mol to 250,000 g/mol, as measured by gel permeation chromatography.

18. The process of claim 15, wherein the olefin homopolymer or copolymer has a Mw distribution with polydispersity index less than 10, less than 6, or less than 3.

19. The process of claim 15, wherein the olefin homopolymer or copolymer has a melting point of less than 135° C.

20. The process of claim 15, wherein the olefin copolymer is obtained having a comonomer content from 0.1 weight percent (wt %) to 50 wt %, from 1 wt % to 35 wt %, from 2 to 20 wt %, or from 3 wt % to 10 wt %.
